(19) United States
(12) Patent Application Publication
(10) Pub. No.: US 2026/0050844 A1
(43) Pub. Date: Feb. 19, 2026

(54) SYSTEMS AND METHODS FOR ITINERARY ADJUSTMENT FOR REAL-TIME TRAVEL DISRUPTION MANAGEMENT

(71) Applicant: SIMPLENIGHT, INC., Miami, FL (US)

(72) Inventors: Solito Reyes, II, Toms River, NJ (US); Mark Halberstein, North Miami Beach, FL (US)

(21) Appl. No.: 19/371,434

(22) Filed: Oct. 28, 2025

Related U.S. Application Data
(63) Continuation-in-part of application No. 19/197,213, filed on May 2, 2025.
(60) Provisional application No. 63/641,512, filed on May 2, 2024.

(51) Int. Cl. G06Q 10/02; G06Q 10/0833; G06Q 50/12

(52) U.S. Cl. CPC G06Q 10/021; G06Q 10/025; G06Q 10/0833; G06Q 50/12

(57) ABSTRACT

A system for automated adjustment of a travel itinerary, comprising: a processor; and a memory coupled to the processor, the memory having instructions stored thereon that, when executed by the processor, cause the system to: receive itinerary data including at least one travel segment selected from a flight, lodging, transportation service, event, or activity; monitor a plurality of data sources including at least one of geolocation data, traffic data, flight data, hotel reservation data, or external event data to detect a potential disruption to the travel itinerary; determine, based on the detected potential disruption, one or more adjustment options for the travel itinerary; initiate communication with a user to confirm a selected adjustment option; execute the selected adjustment option by performing at least one of modifying, cancelling, or rebooking a travel segment; and update the travel itinerary in real time within an itinerary builder interface.

### CROSS-REFERENCE TO RELATED APPLICATION

This application claims the benefit of, and priority to U.S. patent application Ser. No. 19/197,213, filed on May 2, 2025, which claims priority to U.S. Provisional Patent Application No. 63/641,512, filed on May 2, 2024, the entire contents of both applications are hereby incorporated herein by reference in their entirety.

### TECHNICAL FIELD

The present application relates to systems and methods for a personal agent, and, more specifically, to a system and method for a personal travel agent, which utilizes artificial intelligence. The present application further relates to travel management systems and methods, more particularly, to AI-assisted systems and methods that monitor live signals, predict itinerary disruptions, generate alternative plans under user and vendor constraints, autonomously execute bookings and communications, and maintain an auditable state across an end-to-end travel journey.

### BACKGROUND

Most travel planning sites operate by providing users with tools and information to research, compare, and book various aspects of travel, including flights, accommodation, transportation, activities, and more. However, the abundance of choices on travel planning sites can be overwhelming for some users. Sorting through numerous flights, hotels, and activities can lead to decision fatigue and make it challenging to find the best option. Moreover, there are often hidden fees and fine print, limited personalization to individual needs, reliance on limited accessible reviews, and price discrepancies, which make travel planning a tedious and challenging task.

Additionally, conventional itinerary tools assemble flights, ground transportation, lodging, and activities but offer limited or no assistance when unexpected events occur (traffic delays, misplaced documents, venue capacity changes, etc.). Travelers must manually rebook segments, notify hotels, coordinate couriers, and reconcile visas and forms, often across disparate systems and communication channels.

Accordingly, there is a need for an improved travel planning system that can assist a user with personalized recommendations in order to make informed, economical travel plans. There is also a need for a unified “adjustment concierge” that (i) anticipates disruption, (ii) proposes or executes remedies spanning multiple vendors and segments, and (iii) handles cross-dependencies (e.g., knock-on hotel check-in times, transfer reservations, declarations, and visas).

### SUMMARY

In accordance with aspects of the present disclosure, a system for generating a travel recommendation includes a processor and a memory coupled to the processor, the memory having instructions stored thereon, which when executed by the processor, cause the system to: receive a first user input indicating a travel request; determine user attributes based on the first user input, the user attributes including at least one of user travel preferences, user demographics, or historical user input data; generate a travel recommendation based on an output of a neural network, the neural network configured to predict relevance scores for a plurality of inventory items based on the user attributes; display the travel recommendation including at least one inventory item selected based on the output of the neural network; and automatically initiate a travel booking based on the travel recommendation.

In an aspect of the present disclosure, the user attributes may be determined by applying natural language processing to the first user input to extract at least one of intent indicators, contextual information, or preference-related keywords. The user attributes may be stored in a profile database for generating future travel recommendations.

In another aspect of the present disclosure, the first user input may be received via a conversational user interface configured to accept at least one of voice input, text input, or image input.

In yet another aspect of the present disclosure, the instructions, when executed by the processor, may further cause the system to: receive a second user input indicating a modification request, the modification request related to the selected at least one inventory item; and modify the travel recommendation based on the second user input.

In a further aspect of the present disclosure, generating the travel recommendation may include: generating a plurality of vectors, each vector corresponding to a feature of the at least one inventory item; applying a weighting factor to each vector based on the user attributes to produce a weighted score, the weighted score indicating a relevance of the feature to a corresponding user attribute; and combining weighted scores to generate a relevance score for the at least one inventory item. The at least one inventory item may be selected for inclusion in the travel recommendation if the relevance score exceeds a predefined threshold.

In yet a further aspect of the present disclosure, the at least one inventory item may include at least one of a flight, a hotel, a travel activity, a dining reservation, or a transportation service.

In an aspect of the present disclosure, the instructions, when executed by the processor, may further cause the system to output an alert indicating confirmation of the travel booking, the alert including at least one of an e-mail, short message service (SMS) message, an in-application notification, or push notification.

In another aspect of the present disclosure, the system may further include a plurality of agents, each agent configured to generate a portion of a travel recommendation within a distinct category of a plurality for travel categories including at least one of lodging, transportation, dining, entertainment, or activities.

In yet another aspect of the present disclosure, each agent may include a skin associated with custom traits including at least one of a vocabulary, a layout, or an interface tools. The skin may be based on the distinct category of the agent.

In a further aspect of the present disclosure, each inventory item may be represented as a vector. Each vector may be updated in real time based on at least one of current availability or pricing of an associated inventory item.

In accordance with aspects of the present disclosure, a method for generating a travel recommendation includes: receiving a first user input indicating a travel request; determining user attributes based on the first user input, the user attributes including at least one of user travel preferences, user demographics, or historical user input data; generating a travel recommendation based on an output of a neural network, the neural network configured to predict relevance scores for a plurality of inventory items based on the user attributes; displaying the travel recommendation including at least one inventory item selected based on the output of the neural network; and automatically initiating a travel booking based on the travel recommendation.

In an aspect of the present disclosure, determining the user attributes may include applying natural language processing to the first user input to extract at least one of intent indicators, contextual information, or preference-related keywords. The user attributes may be stored in a profile database for generating future travel recommendations.

In another aspect of the present disclosure, the method may further include: receiving a second user input indicating a modification request, the modification request related to the selected at least one inventory item; and modifying the travel recommendation based on the second user input.

In yet another aspect of the present disclosure, the neural network may generate the output by: generating a plurality of vectors, each vector corresponding to a feature of the at least one inventory item; applying a weighting factor to each vector based on the user attributes to produce a weighted score, the weighted score indicating a relevance of the feature to a corresponding user attribute; and combining weighted scores to generate a relevance score for the at least one inventory item. The at least one inventory item may be selected for inclusion in the travel recommendation if the relevance score exceeds a predefined threshold.

In a further aspect of the present disclosure, displaying the travel recommendation may include displaying at least one of a flight, a hotel, a travel activity, a dining reservation, or a transportation service.

In an aspect of the present disclosure, the method may further include outputting an alert indicating confirmation of the travel booking, the alert including at least one of an e-mail, short message service (SMS) message, an in-application notification, or push notification.

In another aspect of the present disclosure, generating the travel recommendation may include retrieving a plurality of agents, each agent configured to generate a portion of the travel recommendation within a distinct category of a plurality for travel categories including at least one of lodging, transportation, dining, entertainment, or activities.

In yet another aspect of the present disclosure, retrieving the plurality of agents may include determining a skin for each agent, the skin associated with custom traits including at least one of a vocabulary, a layout, or an interface tools. The skin may be based on the distinct category of the agent.

In a further aspect of the present disclosure, generating the travel recommendation may include representing each inventory item as a vector. Each vector may be updated in real time based on at least one of current availability or pricing of an associated inventory item.

In accordance with aspects of the present disclosure, a non-transitory computer readable storage medium includes instructions that, when executed by a computer, cause the computer to perform a method for digital rights management, the method including: receiving a first user input indicating a travel request; determining user attributes based on the first user input, the user attributes including at least one of user travel preferences, user demographics, or historical user input data; generating a travel recommendation based on an output of a neural network, the neural network configured to predict relevance scores for a plurality of inventory items based on the user attributes; displaying the travel recommendation including at least one inventory item selected based on the output of the neural network; and automatically initiating a travel booking based on the travel recommendation.

Also disclosed is an AI-powered adaptive travel itinerary management platform or adjustment concierge platform that overcomes the limitations of conventional systems by autonomously monitoring real-time data, predicting disruptions, and dynamically adjusting travel itineraries.

In one aspect according to the present disclosure, machine learning models, such as neural networks and ensemble models, are employed to predict the likelihood of itinerary disruptions based on inputs including traffic data, weather forecasts, airline reservation information, and historical travel patterns. An attention mechanism may be used to highlight the most relevant features of the input data, thereby improving prediction accuracy.

In another aspect according to the present disclosure, the system includes a compliance module that identifies required travel documentation (e.g., visas, permits, or vaccination records) when itineraries change. When missing documentation is detected, the system can automatically initiate applications by populating governmental forms, optionally using natural language processing (NLP) models to parse complex regulatory requirements.

In another aspect of the present disclosure, the system further improves traveler experience through a reinforcement learning model that optimizes rebooking decisions according to user preferences, loyalty programs, and corporate travel policies. The system also updates traveler-specific profiles with historical outcomes, permitting the platform to continually improve recommendations over time.

By autonomously rebooking reservations, requesting travel documentation, and generating updated itineraries in real time, the systems and methods according to the present disclosure transform travel management from a reactive, manual process into a proactive, self-healing system. This technical improvement not only reduces traveler stress and costs but also ensures greater compliance with regulatory requirements and minimizes disruptions to travel plans.

In accordance with aspects of the present disclosure, a system for automated adjustment of a travel itinerary includes a processor and a memory coupled to the processor, the memory having instructions stored thereon that, when executed by the processor, cause the system to: receive itinerary data including at least one travel segment selected from a flight, lodging, transportation service, event, or activity; monitor a plurality of data sources including at least one of geolocation data, traffic data, flight data, hotel reservation data, or external event data to detect a potential disruption to the travel itinerary; determine, based on the detected potential disruption, one or more adjustment options for the travel itinerary; initiate communication with a user to confirm a selected adjustment option; execute the selected adjustment option by performing at least one of modifying, cancelling, or rebooking a travel segment; and update the travel itinerary in real time within an itinerary builder interface.

In an aspect of the present disclosure, detecting the potential disruption may include comparing a user current location derived from a navigation service to a scheduled departure location and determining that the user will not reach the scheduled departure location within a required time.

In another aspect of the present disclosure, the instructions, when executed by the processor, may further cause the system to receive a user authorization defining categories of automated actions and automatically perform an authorized category of itinerary adjustment without further user input.

In a further aspect of the present disclosure, the adjustment options may include identifying an alternative flight, rebooking ground transportation, updating hotel check-in times, or rescheduling a travel activity.

In yet another aspect of the present disclosure, executing the selected adjustment option may include accessing one or more third-party booking platforms, cancelling a prior reservation, confirming a new reservation, and synchronizing updated information with a hotel concierge system.

In an aspect of the present disclosure, the instructions, when executed by the processor, may further cause the system to initiate communication with a concierge service at a lodging location, transmit a message requesting assistance with retrieval or delivery of an item, and monitor progress of the retrieval or delivery through integration with a courier tracking system.

In another aspect of the present disclosure, the instructions, when executed by the processor, may further cause the system to automatically reschedule at least one travel segment in response to determining that the item will not arrive before a scheduled departure.

In a further aspect of the present disclosure, the instructions, when executed by the processor, may further cause the system to coordinate a multi-destination itinerary including at least two travel legs, communicate with a lodging provider associated with a first destination to arrange retrieval of luggage, and instruct a courier to deliver the luggage to a second lodging provider corresponding to a modified destination.

In yet another aspect of the present disclosure, the instructions, when executed by the processor, may further cause the system to provide the user with real-time notifications identifying a current location of the luggage, an expected delivery time, and confirmation of receipt at a final destination.

In an aspect of the present disclosure, the instructions, when executed by the processor, may further cause the system to store a plurality of entertainment or activity options for a given time period, receive a user selection of an anchor activity, automatically adjust one or more dependent activities preceding or following the anchor activity based on timing, proximity, or availability, and coordinate with event hosts, venue systems, or transportation services to confirm all updated reservations.

In another aspect of the present disclosure, the instructions, when executed by the processor, may further cause the system, through an artificial intelligence adjustment concierge, to determine visa or entry requirements for a destination based on user nationality and itinerary details, populate visa or declaration forms using user data stored in the system, analyze processing times and reliability metrics of available service providers, and submit or prepare the visa or declaration forms for user review and approval.

In a further aspect of the present disclosure, the artificial intelligence adjustment concierge and a personnel travel administrator may cooperate to verify validity of travel documents, generate alerts for impending expirations, and initiate renewal or replacement procedures as needed.

In yet another aspect of the present disclosure, the artificial intelligence adjustment concierge may include a multi-agent architecture configured to learn from historical user behavior, prior itinerary adjustments, and contextual conditions to refine predictive accuracy and decision efficiency.

In an aspect of the present disclosure, the artificial intelligence adjustment concierge may maintain a user model including intent data, event prioritization, and tolerance thresholds for delay or modification, and dynamically adjust decision policies based on the user model.

In another aspect of the present disclosure, the artificial intelligence adjustment concierge may synchronize itinerary updates with connected travel companions to maintain consistency across group travel plans.

In a further aspect of the present disclosure, the artificial intelligence adjustment concierge may operate as an orchestration layer that coordinates data exchange among an itinerary builder, a personnel travel administrator, and external booking, communication, and documentation systems.

In accordance with aspects of the present disclosure, a method for automated adjustment of a travel itinerary includes receiving itinerary data including at least one travel segment selected from a flight, lodging, transportation service, event, or activity; monitoring a plurality of data sources to detect a potential disruption to the travel itinerary; determining, based on the detected potential disruption, one or more adjustment options for the travel itinerary; initiating communication with a user to confirm a selected adjustment option; executing the selected adjustment option by performing at least one of modifying, cancelling, or rebooking a travel segment; and updating the travel itinerary in real time within an itinerary builder interface.

In an aspect of the present disclosure, the method may further include automatically submitting travel documentation based on a determined visa or entry requirement, the travel documentation populated with user data stored in a user profile.

In another aspect of the present disclosure, the method may further include retrieving a user authorization that defines categories of automated itinerary changes and automatically executing an itinerary change within an authorized category without requiring additional confirmation.

In accordance with aspects of the present disclosure, a non-transitory computer-readable storage medium includes instructions stored thereon that, when executed by a processor, cause a system to perform the method for automated adjustment of a travel itinerary as described herein.

### BRIEF DESCRIPTION OF THE DRAWINGS

A better understanding of the features and advantages of the disclosed technology will be obtained by reference to the following detailed description that sets forth illustrative embodiments, in which the principles of the technology are utilized, and the accompanying drawings of which:

FIG. 1 is an illustration of a system for a personal agent, in accordance with aspects of the present disclosure;

FIG. 2 is a block diagram of example components of the controller of FIG. 1, in accordance with aspects of the present disclosure;

FIG. 3 is a block diagram of a machine learning network with inputs and outputs of a deep learning neural network, in accordance with aspects of the present disclosure;

FIG. 4 is a diagram of layers of the machine learning network of FIG. 3, in accordance with aspects of the present disclosure;

FIG. 5 is an illustration of a travel planning system within the system of FIG. 1, in accordance with aspects of the present disclosure;

FIGS. 6-8 are exemplary interfaces of the system of FIG. 5, in accordance with aspects of the present disclosure;

FIG. 9 is a flow diagram of an exemplary use of the systems of FIGS. 1 and 5, in accordance with aspects of the present disclosure;

FIG. 10 is a block diagram of an exemplary system architecture for adaptive travel itinerary management, in accordance with aspects of the present disclosure;

FIG. 11 is a block diagram of an exemplary system architecture for disruption-risk evaluation, in accordance with aspects of the present disclosure;

FIG. 12 is a block diagram of an exemplary system architecture for replanning, in accordance with aspects of the present disclosure;

FIG. 13 is a block diagram of an exemplary system architecture for execution and communication, in accordance with aspects of the present disclosure;

FIG. 14 is a block diagram of an exemplary system architecture for commitment-based evaluations, in accordance with aspects of the present disclosure;

FIG. 15 is a block diagram of an exemplary system architecture for missed flight replanning, in accordance with aspects of the present disclosure;

FIG. 16 is a block diagram of an exemplary system architecture for forgotten passport remediation, in accordance with aspects of the present disclosure;

FIG. 17 is a block diagram of an exemplary system architecture for luggage re-routing, in accordance with aspects of the present disclosure;

FIG. 18 is a block diagram of an exemplary system architecture for anchor-based event planning, in accordance with aspects of the present disclosure; and

FIG. 19 is a block diagram of an exemplary system architecture for document automation, in accordance with aspects of the present disclosure.

### DETAILED DESCRIPTION

The present application relates to systems and methods for a personal agent, and, more specifically, to a system and method for a personal travel agent, which utilizes artificial intelligence.

For the purpose of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Various alterations, rearrangements, substitutions, and modifications of the features illustrated herein, and any additional applications of the principles of the present disclosure as illustrated herein, which would occur to one skilled in the relevant art and having possession of this disclosure, are to be considered within the scope of the present disclosure.

As used herein, the term “travel agent” includes a computer program, software application and/or software module designed to assist users in booking travel-related products and/or services, such as flights, hotels, rental cars, and vacation packages. For example, a travel agent may utilize various algorithms, databases, and/or interfaces, which may provide users with options, pricing information, and booking capabilities. The travel agent may provide automated assistance to users by analyzing their preferences, budget, and travel requirements to offer suitable options, and/or may retrieve and display relevant travel information such as flight schedules, hotel amenities, and destination guides to help users make informed decisions. For example, the travel agent may incorporate personalization features to tailor recommendations based on users' past booking history, preferences, and search behavior. The travel agent may be accessible through websites, mobile apps, messaging platforms, and/or chatbots, which may be designed to offer a user-friendly, flexible experience. The travel agent and/or travel system platform may prioritize user privacy and data security by implementing robust measures to protect users' personal information and sensitive data collected during the recommendation process.

As used herein, the term “personnel travel administrator” includes a computer program, software application and/or software module designed to manage and/or streamline various aspects of travel arrangements and logistics. For example, the personnel travel administrator may streamline the process of applying for entry into/exit from a country, including various visas, thereby ensuring efficiency and compliance with various state policies. The personnel travel administrator may also automatically monitor and/or dynamically update the status of various documentation such passports to ensure user information is up to date in advance of traveling. If documentation (e.g., visa or passport) needs to be renewed, the personnel travel administrator may streamline the process of gathering data, generating, and/or submitting required documentation.

As used herein, the term “visual promoter” includes a computer program, software application and/or software module designed to promote products, services, and/or brands using visual content. For example, a visual promoter may leverage various technologies to create, distribute, and/or display visual promotional materials across different platforms and channels, such as a travel system. The visual promoter may employ data analytics and machine learning algorithms to analyze user behavior, preferences, and demographics, promoting targeted advertising campaigns tailored to specific audiences. For example, the visual promoter may incorporate personalization features to customize promotional content based on user interactions, purchase history, and preferences, enhancing engagement and conversion rates. The visual promoter may monitor and analyze the performance of visual promotional campaigns using metrics such as impressions, clicks, conversions, and engagement metrics to optimize future campaigns.

As used herein, the term “itinerary builder” includes a computer program, software application and/or software module designed to create detailed plans for their trips, such as gathering, organizing, and presenting information about various travel-related activities and arrangements. For example, the itinerary builder may provide comprehensive information about a chosen destination, including points of interest, attractions, landmarks, restaurants, hotels, transportation options, and/or local events. The itinerary builder may generate and/or display interactive maps to visualize the locations of various attractions, accommodations, and activities, helping users understand the geographical layout of their itinerary. The itinerary builder may provide real-time updates and notifications regarding changes to travel plans, such as flight delays, cancellations, or itinerary adjustments, ensuring users stay informed throughout their trip. Further, the itinerary builder allow users to share their itineraries with travel companions, friends, or family members, facilitating coordination and communication during the trip planning process. The itinerary builder may offer offline access to users, allowing them to access their travel plans and information even without an internet connection, useful for when they are traveling to remote or unfamiliar destinations.

As used herein, the term “travel recommendation engine” includes a computer program, software application and/or software module designed to analyze user preferences, demographics, historical data, and/or contextual information to provide personalized travel recommendations. The travel recommendation engine may leverage machine learning, artificial intelligence, and data analytics techniques to suggest destinations, accommodations, activities, and travel itineraries that align with users' interests and preferences. For example, the travel recommendation engine may generate and/or utilize user profiles based on demographic information, travel history, preferences, interests, and behavior patterns collected from user interactions with a travel system. The travel recommendation engine may analyze a vast amount of travel-related content, including user reviews, ratings, travel guides, blogs, and social media posts, to extract insights and identify relevant recommendations.

Further, the travel recommendation engine may utilize collaborative and/or content-based filtering, which compares user preferences and behaviors to match users' stated preferences, such as destination type, activities, budget, and travel dates. In doing so, the travel recommendation engine may consider contextual factors such as current location, weather conditions, local events, and travel trends to provide timely and relevant recommendations tailored to users' immediate needs and interests. The travel recommendation engine may adapt and refines recommendations based on user feedback, interactions, and/or changes in preferences over time, ensuring that recommendations remain relevant and up-to-date. For example, the travel recommendation engine may monitor and evaluate the performance of recommendations using metrics such as click-through rates, conversion rates, and user engagement, optimizing its algorithms to improve recommendation accuracy and effectiveness.

As used herein, the term “dynamic packager” includes a computer program, software application and/or software module designed to create custom travel packages by dynamically combining various travel components such as flights, accommodations, activities, and transfers based on user preferences, availability, and pricing data. The dynamic packager may leverage algorithms, APIs, and data integrations to assemble personalized travel packages in real-time, while ensuring compliance with supplier and/or vendor policies for providing discounts. The dynamic packager may utilize pricing algorithms and predictive analytics to optimize the pricing of travel packages based on factors such as demand, seasonality, inventory levels, and competitor pricing, offering competitive rates to users. For example, the dynamic packager may offer bundled discounts and/or promotions for booking multiple travel components together as part of a package, providing cost savings and incentives for users to purchase bundled offerings and/or may employ cross-selling and upselling techniques to suggest additional services or upgrades to enhance the travel experience, such as airport transfers, travel insurance, guided tours, or premium accommodations. The dynamic packager may also allow users to mix and match different travel components to create flexible packages that meet their specific needs and preferences, enabling them to build their ideal itinerary.

As used herein, a “user” includes an entity, which can be a human, an organization, a group, and/or automated system, or any other identifiable entity, that interacts with a computer system, software application, a piece of software acting on behalf of another entity, and/or technology platform to perform actions, access resources, and/or receive information. The user typically has a unique identifier (e.g., username or ID) and may have associated permissions or privileges governing their interactions with the system.

As used herein, “travel” products and/or services may include may include a broad spectrum of offerings aimed at meeting the needs and/or preferences of travelers, enhancing their overall travel experiences, and ensuring convenience, comfort, and safety throughout their journeys, such as transportation, accommodations, travel agencies, tours and activities, travel insurance, travel technology, visa and documentation services, travel accessories and gear, dining and food services, and/or currency exchange and banking services. Further, travel products and/or services may include various lifestyle offerings designed to cater to unique preferences, values, and/or aspirations, such as those offerings contributing to the cultivation of their desired way of life and personal expression. The travel products and/or services may be utilized for various purposes, including recreation, tourism, exploration, business, migration, commuting, and/or lifestyle related needs.

The present disclosure may be utilized by and/or incorporated into the Simplenight® platform, including the Global Experience Platform® (GEP) and/or Travel and Lifestyle platform. Simplenight® is a global technology company building innovative enterprise solutions including customizable bookability, cloud-based distribution, dynamic packaging, and merchandising, which delivers ancillary revenue and increased customer loyalty for its partners. It will be understood that the technology in the present disclosure is configured to operate on a variety of devices, as described herein.

The disclosure herein addresses the challenge of creating an adaptive, interactive, and personalized travel booking experience through a conversational interface, which understands natural language inputs, offers tailored recommendations, and simplifies the process of planning and booking travel arrangements. In doing so, the disclosure herein provides a seamless interface for inputting travel preferences, receiving personalized options, and refining plans based on user feedback.

Further, the disclosure herein exemplifies a modular approach, wherein an AI Agent dynamically interacts with specialized components, thereby allowing for flexible adaptation and scaling of services. The various components may include a frontend web client, API gateway services, a user profile, an AI agent, a natural language processing engine and/or large language model, a text-to-speech engine, a booking API, an itinerary generator, and/or a chat session database.

The frontend web client (UI) may serve as the primary interface for users, accepting both text and voice inputs, and displaying system responses, e.g., designed for user-friendliness and accessibility, facilitating the initial user-system interaction. The API gateway (AG) may be the intermediary, routing requests and responses between the UI and backend services, thereby ensuring efficient traffic management, security (e.g., via authentication through the User Profile), and scalability. The user profile (UP) may manage user authentication and stores preferences, allowing for personalized interactions, and may enhance security by authenticating user identities and allows the AI Agent to tailor responses and recommendations. The AI Agent (AIA) may be the core intelligence of the system, directing the flow of information and decisions, processing user queries via NLP, managing interactions with the Booking API and Itinerary Generation, and using feedback for service improvement. The Natural Language Processing & Large Language Model (NLP) may interpret user inputs, extracting intent and relevant data, which is crucial for permitting the system to understand and process natural language queries and feedback. The Text-to-Speech Engine (TTS) may convert text responses into audio, providing a more interactive and accessible user experience that bridges the gap between textual data and auditory feedback. The Booking API (BA) may connect the system to external travel services, retrieving inventory options like hotel bookings based on user queries, which are essential for providing real-time, relevant travel options to users. The Itinerary Generation (IG) may compile user preferences and/or bookings into a coherent itinerary, transforming individual selections into a structured travel plan. The Chat Session Database (CSD) may collect user interactions and feedback, directly informing the continuous refinement of the NLP model, providing a feedback loop that is fundamental for the system's ability to learn and improve over time.

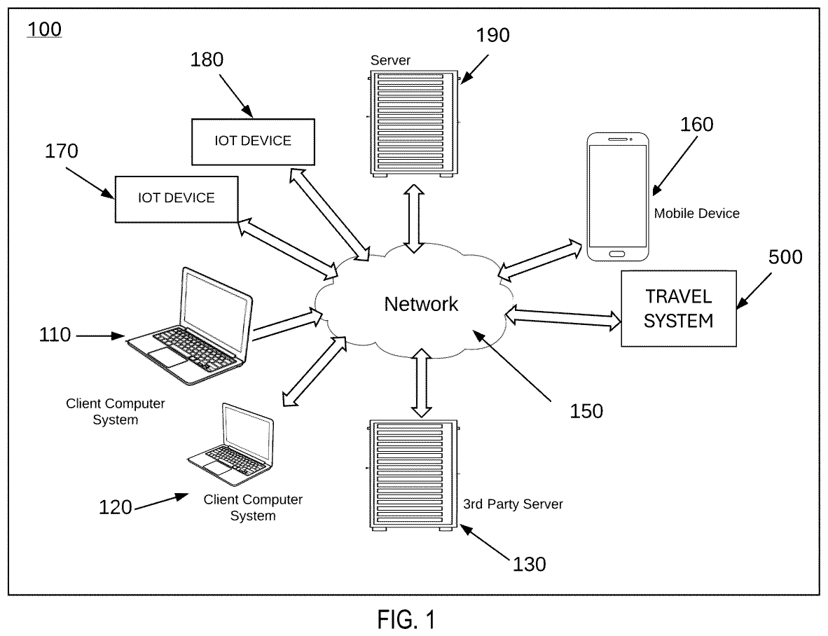

Referring to FIG. 1, there is shown an illustration of an exemplary system 100 for using a personal agent in accordance with aspects of the present disclosure. The system 100 includes one or more client computer systems 110, 120, a cloud system 130, a network 150, one or more mobile devices 160, one or more Internet of things (IOT) devices 170, 180, a server 190, and/or system 500. The client computer systems 110, 120 communicate with the server 190 across the network 150. In aspects, multiple servers 190 may be used in a distributed architecture and/or in a cloud.

The network 150 may be wired or wireless, and can utilize technologies such as Wi-Fi, Ethernet, Internet Protocol, 4G, and/or 5G, or other communication technologies. The network 150 may include, for example, but is not limited to, a cellular network, residential broadband, satellite communications, private network, the Internet, local area network, wide area network, storage area network, campus area network, personal area network, or metropolitan area network.

As will be described in more detail below, the cloud system 130 may implement statistical models and/or machine learning models (e.g., neural network) that process the collected data to identify potential threat behaviors. The term “machine learning model” may include, but is not limited to, neural networks, recurrent neural networks (RNN), generative adversarial networks (GAN), decision trees, Bayesian Regression, Naive Bayes, nearest neighbors, least squares, means, and support vector machine, among other data science and machine learning techniques which persons skilled in the art will recognize.

The illustrated networked environment is merely an example. In embodiments, other systems, servers, and/or devices not illustrated in FIG. 1 may be included. In embodiments, one or more of the illustrated components may be omitted. Such and other embodiments are contemplated to be within the scope of the present disclosure.

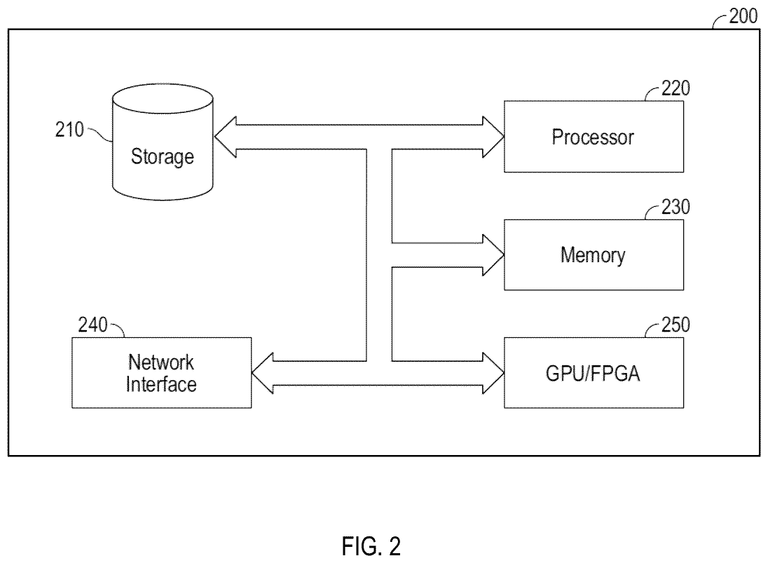

Referring now to FIG. 2, exemplary components of the controller 200 are shown. The controller 200 generally includes a storage or database 210, one or more processors 220, at least one memory 230, and a network interface 240. In aspects, the controller 200 may include a graphical processing unit (GPU) 250, which may be used for processing machine learning network models.

The database 210 can be located in storage. The term “storage” may refer to any device or material from which information may be capable of being accessed, reproduced, and/or held in an electromagnetic or optical form for access by a computer processor. Storage may be, for example, volatile memory such as RAM, non-volatile memory, which permanently holds digital data until purposely erased, such as flash memory, magnetic devices such as hard disk drives, and optical media such as a CD, DVD, Blu-ray Disc™, or the like.

In aspects, data may be stored on the controller 200, including, for example, user accounts, permissions, licensing documentation, and/or other data. The data can be stored in the database 210 and sent via the system bus to the processor 220. The database 210 may store information in a manner that satisfies information security standards and/or government regulations, such as Systems and Organization Controls (e.g., SOC 2), General Data Protection Regulation (GDPR), and/or International Organization for Standardization (ISO) standards.

As will be described in more detail later herein, the processor 220 executes various processes based on instructions that can be stored in the at least one memory 230 and utilizing the data from the database 210. With reference also to FIG. 1, a request from a user device, such as a mobile device or a client computer, can be communicated to the controller 200 through the network interface 240. The illustration of FIG. 2 is exemplary, and persons skilled in the art will understand that other components may exist in controller 200. Such other components are not illustrated for clarity of illustration.

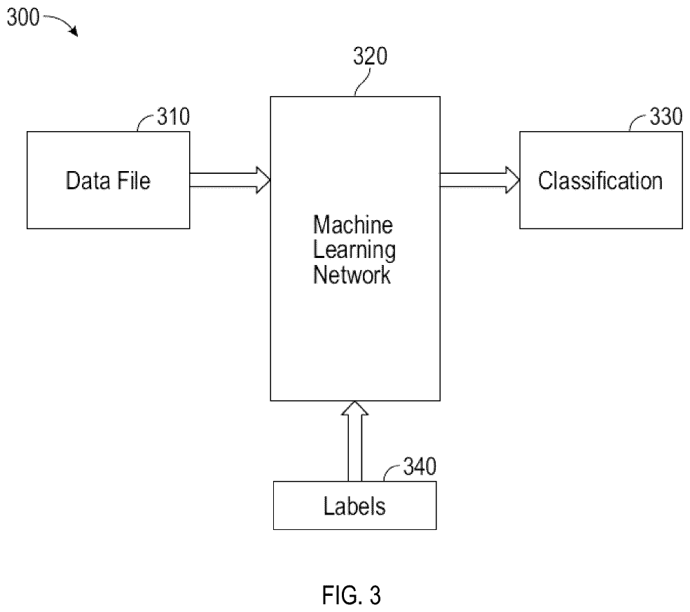

With reference to FIG. 3, a block diagram for a machine learning network 320 for classifying data in accordance with some aspects of the disclosure is shown. In some systems, a machine learning network 320 may include, for example, a convolutional neural network (CNN), a regression and/or a recurrent neural network. A deep learning neural network includes multiple hidden layers. As explained in more detail below, the machine learning network 320 may leverage one or more classification models 330 (e.g., CNNs, decision trees, a regression, Naive Bayes, k-nearest neighbor) to classify data. In aspects, the classification model 300 may use a data file 310 and labels 340 for classification. The machine learning network 320 may be executed on the controller 200 (FIG. 2). Persons of ordinary skill in the art will understand the machine learning network 320 and how to implement it.

In machine learning, a CNN is a class of artificial neural network (ANN). The convolutional aspect of a CNN relates to applying matrix processing operations to localized portions of data, and the results of those operations (which can involve dozens of different parallel and serial calculations) are sets of many features that are delivered to the next layer. A CNN typically includes convolution layers, activation function layers, deconvolution layers (e.g., in segmentation networks), and/or pooling (typically max pooling) layers to reduce dimensionality without losing too many features. Additional information may be included in the operations that generate these features. Providing unique information, which yields features that give the neural networks information, can be used to provide an aggregate way to differentiate between different data input to the neural networks.

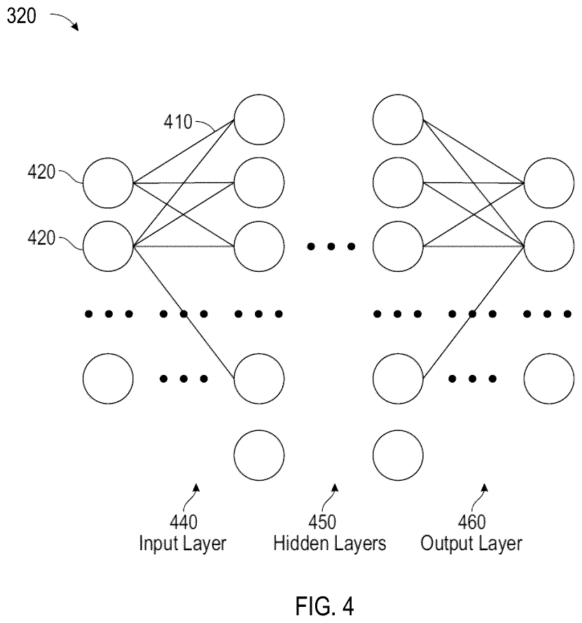

Referring to FIG. 4, generally, a machine learning network 320 (e.g., a convolutional deep learning neural network) includes at least one input layer 440, a plurality of hidden layers 450, and at least one output layer 460. The input layer 440, the plurality of hidden layers 450, and the output layer 460 all include neurons 420 (e.g., nodes). The neurons 420 between the various layers are interconnected via weights 410. Each neuron 420 in the machine learning network 320 computes an output value by applying a specific function to the input values coming from the previous layer. The function that is applied to the input values is determined by a vector of weights 410 and a bias. Learning, in the deep learning neural network, progresses by making iterative adjustments to these biases and weights. The vector of weights 410 and the bias are called filters (e.g., kernels) and represent particular features of the input (e.g., a particular shape). The machine learning network 320 may output logits. Although CNNs are used as an example, other machine learning classifiers are contemplated.

The machine learning network 320 may be trained based on labeling training data to optimize weights. For example, samples of feature data may be taken and labeled using other feature data. In some methods in accordance with this disclosure, the training may include supervised learning or semi-supervised. Persons of ordinary skill in the art will understand training the machine learning network 320 and how to implement it.

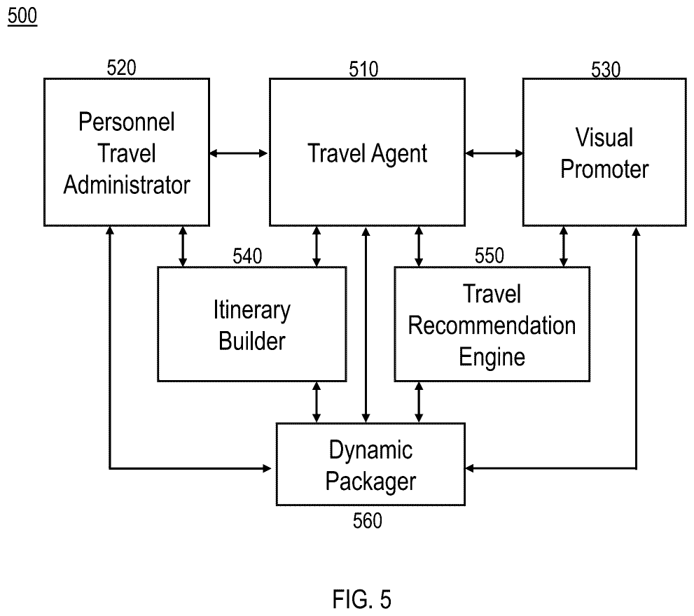

As shown in FIG. 5, system 500 promotes the interaction of various modules within system 500. System 500 may include interfaces such as a travel agent 510, personnel travel administrator 520, visual promoter 530, itinerary builder 540, travel recommendation engine 550, and a dynamic packager 560.

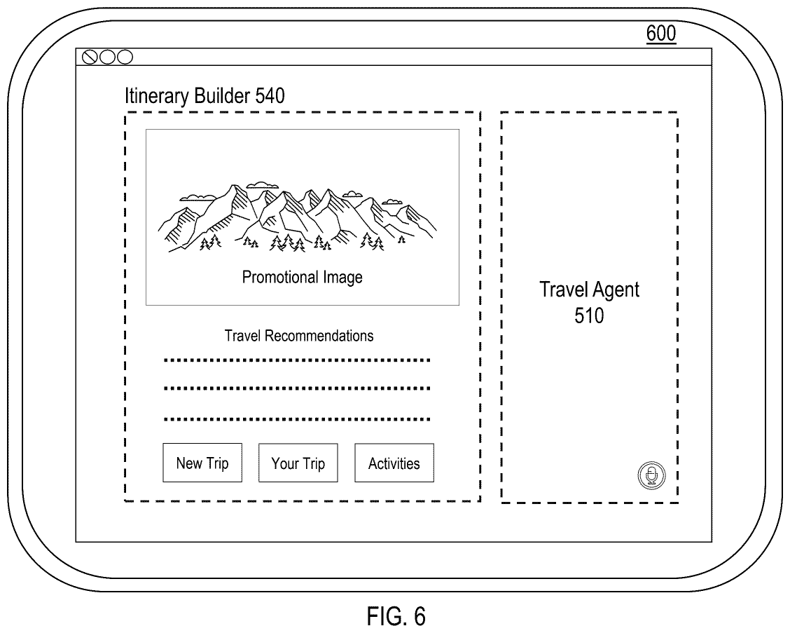

Travel agent 510 is configured to display an interactive experience for users by gathering information, providing recommendations, building an itinerary, booking, and/or purchasing travel-related products and services. Travel agent 510 incorporates a user experience/user interface (UX/UI) paradigm, which combines natural language processing (NLP), a large language model (LLM), multimodality, multiagency, speech to text, text to speech (TTS) engines, traditional web UI elements, sound imagery, and/or generative imagery with an artificial intelligence (AI) chatbot scroll (interface 600 of FIG. 6). In aspects, travel agent 510 may be displayed within a web browser and/or as a standalone application. For example, travel agent 510 may appear as an individual module on a web page incorporated with other interfaces. In aspects, travel agent 510 may provide promotional UIs that compare product prices, offer display packaged discounts, and/or other real-time, market-driven, and/or profit-motivated incentives.

Travel agent 510 is configured to develop an interactive, intelligent persona, which permits a user to book trips and build itineraries by conversing with a smart, informed, and fully simulated travel agent. Using a machine learning model, such as machine learning network 320 of FIG. 4, travel agent 510 is trained to converse with a user to obtain and record relevant information. For example, travel agent 510 may produce an audible prompt, for example, “Hello, how can I help you today?” A user may respond normally, similar to how they would communicate with another human, such as “I would like to book a trip to the Bahamas for this upcoming winter.” Travel agent 510 may respond back with prompts designed to gather the user's travel history, preferences, and/or necessary travel documentation.

Travel agent 510 may respond to a user in a vocal tone that matches the user's vocal tone, speech patterns, and/or the user's overall persona. As used herein, a persona includes a detailed profile that captures various aspects of the user's individual characteristics, preferences, behaviors, and/or needs, which may be based on data collected from the user's interactions, activities, and/or demographic information. In aspects, travel agent 510 may include artificial intelligence trained based on the signals and patterns detected in a user's voice, such a vocal pitch, volume, rate of speech, etc. For example, travel agent 510 may speak to the user in a calm, soft-spoken voice, which matches the persona of the user. This has the benefit of putting the user at ease, feeling comfortable with travel recommendations, and/or being more likely to commit to a particular trip.

In aspects, travel agent 510 may be trained on a user's prior selections (e.g., travel-related products and services), preferences (e.g., travel location, time of year, flight duration, cost), and additional persona factors. Travel agent 510 remembers this persona of the user upon return for future trips and/or revision of a current trip. For example, travel agent 510 may remember that a user prefers traveling to the Caribbean during the months of December to January, with a flight duration under five hours. As a result, travel agent 510 may notify a user three months prior to the timeframe about potential bookings and travel deals.

Travel agent 510 is configured to coordinate with travel recommendation engine 550 to make recommendations to a user. In use, travel recommendation engine 550 permits travel agent 510 to provide a communicational path of open discovery, which allows users to explore recommendations, compare travel products, services, experiences, and/or prices within a budget, and receive incentives, and/or obtain discounts in real time.

Generally, travel recommendation engine 550 operates behind the scenes to process recommendations, which may be rendered within an interface of system 500 by travel agent 510 (interface 600 of FIG. 6). The recommendations may be displayed as graphical images, text, videos, audiovisual displays, etc. In aspects, travel recommendation engine 550 may obtain a user inquiry as input and provide contextual answers and/or details based on the specific question(s) posed. For example, a user may ask “What is the shortest flight time to Florida?” and travel recommendation engine may provide a list of flights, times, and prices, in addition to links for booking.

In aspects, travel recommendation engine 550 utilizes artificial intelligence to process a user's historical travel product purchases, current preferences, and selections, and/or predict intelligent, well-matched recommendations including travel products and/or services. To do so, travel recommendation engine 550 may be trained with a variety of information, including all available ratings, reviews, articles, vlogs, blogs, social media, and/or commentary, for all travel and lifestyle products and/or services. Travel recommendation engine 550 may collaborate with visual promoter 530 (described below) to produce tailored recommendations in photos and/or videos for a user. In aspects, travel recommendation engine 550 may use a large language model (LLM) to provide a detailed summary of a product and/or service, which may be derived from processing a network of ratings and reviews from the web. The performance of travel recommendation engine 550 may be evaluated using metrics such as precision, recall, accuracy, and mean average precision, which can help assess the quality and effectiveness of the recommendations generated.

For example, the system 500 can generate travel recommendations using a neural network trained to analyze and match user profile (UP) attributes (e.g., user's preferences, travel history, demographics such as age and gender, prior travel history or destination attributes, booking patterns, or selections, personality traits) to travel inventory items (e.g., flights, hotels, and/or activities). The UP attributes may be determined, for example, by applying natural language processing to user input (e.g., an inquiry, form, or questionnaire) to extract intent indicators, contextual information, and/or preference-related keywords

The neural network may be trained on historical user attributes and corresponding inventory items to determine correlations between the historical user attributes and features of the corresponding inventory items. For instance, during the training phase, the neural network is exposed to historical data, which includes attributes derived from user profiles along with associated travel inventory items previously selected by users. The neural network learns correlations between specific user attributes and corresponding inventory selections by iteratively adjusting its internal parameters, such as weights and biases, using supervised learning techniques, including backpropagation and gradient descent. Specifically, during training, the neural network may compute predictive scores for each travel inventory item, reflecting how closely the item matches a given user profile. Thereafter, the trained neural network can receive user profile attributes as input, and the trained neural network will output various scores representing predicted compatibility between the profile and various travel inventory items. The system 500 then uses this trained neural network to select one or more inventory items having the highest computed scores as the recommended travel items. This trained neural network approach provides personalized and accurate travel recommendations, enhancing the relevance and effectiveness of the recommendation process.

In aspects, the neural network may employ a weighted vector scoring method to generate personalized travel recommendations. For example, the neural network may generate inventory item vectors, each vector representing a feature(s) of an inventory item. The neural network may then apply weighting factors (e.g., weighting derived from the user attributes) to each of these vectors to produce weighted scores. These weighting factors reflect the relative importance of features of travel inventory items based on the user profile, emphasizing attributes that align closely with the user's individual travel objectives. For example, for a user whose profile indicates a preference for family-oriented trips, the system may assign a higher weight to attributes such as child-friendly accommodations, proximity to amusement parks, and availability of group activities, while assigning lower weights to attributes like nightlife or luxury experiences. In another example, a business traveler's profile may prioritize attributes such as travel duration, proximity to conference centers, or premium seating options, with reduced weighting applied to leisure or entertainment options.

The neural network combines the weighted scores, such as by summation or averaging, to generate an overall travel recommendation score (e.g., relevance score) for each inventory item. The inventory items associated with the highest recommendation scores are selected and presented as personalized recommendations to the user. In aspects, inventory items are selected based on scores exceeding a predefined threshold, such as a numerical cutoff value (e.g., >0.75 for scores between 0 and 1; top-N scoring items for percentile) that the system uses to determine whether a travel inventory item is relevant enough to be recommended to the user. This filters out lower-confidence or weakly relevant results. In aspects, a threshold may can adapt based on user context (e.g. a contextually dynamic threshold). For example, a first-time user might have a lower threshold to cast a wider net (e.g., 0.65) while a returning user with detailed preferences might trigger a higher threshold (e.g., 0.85). Overall, this weighted vector scoring method allows the neural network to dynamically adapt recommendations to individual user profiles, enhancing both relevance and personalization of the travel recommendations.

In aspects, travel recommendation engine 550 may perform real-time vectorization of inventory items to enhance personalization and streamline inventory selection. Real-time vectorization generally refers to the process of dynamically encoding inventory data (e.g., flights, accommodations, restaurants, activities, and service bundles) and/or features of inventory items into high-dimensional vectors that represent the semantic and functional characteristics of each item. These vectors may be generated or updated continuously based on changing supplier data (e.g., availability, pricing, descriptive metadata, ratings, time-sensitive promotions), as well as contextual attributes such as location, user intent, seasonal trends, or regional preferences. Each item's vector representation may be compared against the user's attributes (e.g., weights and/or attribute vectors) using similarity metrics to determine the best-matched options. This allows the system 500 to surface personalized recommendations in milliseconds, even as underlying inventory data fluctuates. In addition, the real-time vectorization permits downstream processes, such as itinerary generation or dynamic packaging, to operate on semantically enriched data, improving both recommendation quality and system responsiveness. In aspects, vectorization may be facilitated using embeddings generated by deep learning models, such as BERT-based encoders or collaborative filtering embeddings trained on past booking and selection patterns.

Travel agent 510 is configured to assist users in customizing an itinerary using itinerary builder 540, which includes specific preferences, historical selections, travel locations, and/or other well-matched activities. Itinerary builder 540 is further configured to dynamically display day-to-day details of a trip itinerary, which may serve as a reference point of information between the user and travel agent 510, while also offering alternative travel options and/or market-driven travel incentives.

Generally, itinerary builder 540 is displayed as a graphic UI panel positioned next to travel agent 510 (interface 600 of FIG. 6). In aspects, itinerary builder 540 may render a mix of traditional web UI elements, photos, videos, and/or links as dictated by data collected from travel agent 510. For example, itinerary builder 540 may display a promotional image alongside travel recommendations, in addition to links for bookings based on said recommendations. In aspects, both external and internal products may be displayed together to the user regardless of fees (e.g., both free and payable products). Dynamically packaged products generated by dynamic packager 560 may also be displayed.

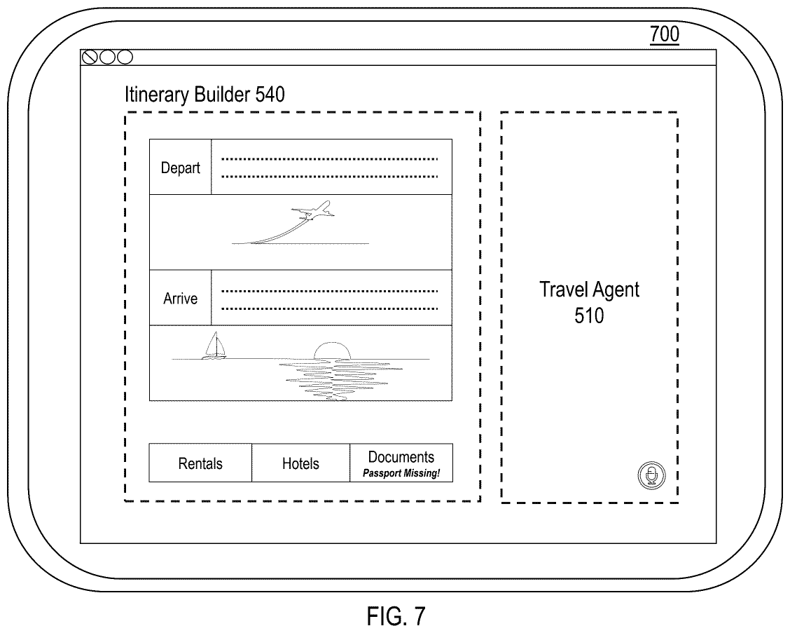

The graphical UI panel of itinerary builder 540 may display a present, day-to-day breakdown of a trip itinerary, including a variety of travel data. Itinerary builder 540 may display dynamically updated details such as trip location, trip duration, recommended products, purchased products, product expirations, product and/or service prices, availability of products and/or services, travel-related appointments, and other important information. For example, a map location and/or photo montage of trip locations may be displayed along a timeline next to planned activities in chronological order (interface 700 of FIG. 7). The display itinerary may be updated in real-time based on input and/or selections made using travel agent 510. In aspects, additional interface controls may be displayed for product and/or service options, selection and revision of further product details, submission of travel documents, and other helpful information. For example, a screen may display options for adding a car rental, hotel booking, restaurant reservation, etc.

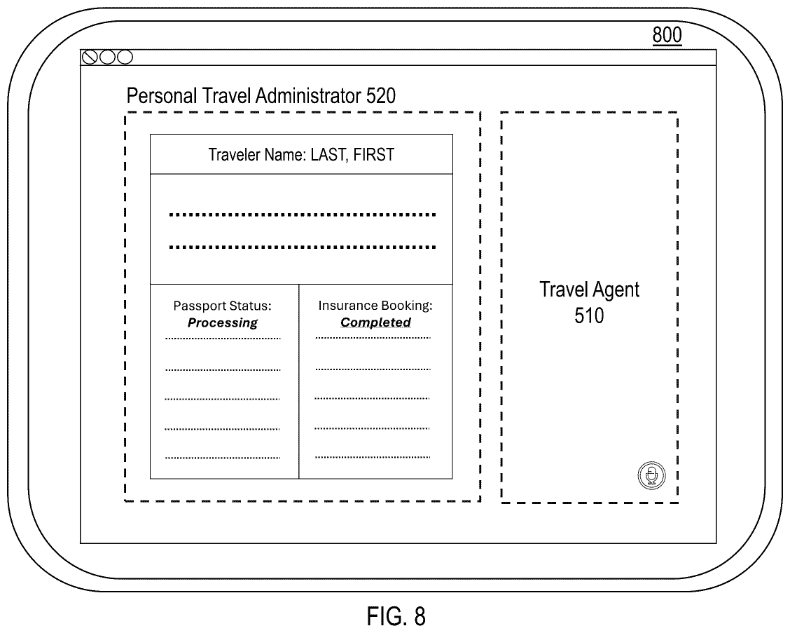

Itinerary builder 540 may be configured to display an alert to a user, such as an indication that important information is still needed in preparation for an upcoming trip. To assist with such tedious information gathering, itinerary builder 540, travel agent 510, and/or other interfaces within system 500 may utilize personnel travel administrator 520. As shown in FIG. 8, personnel travel administrator 520 may provide an interface for viewing traveler information and completing document submissions (e.g., passport), filings, etc. For example, personnel travel administrator 520 may display information for and facilitate submission of a passport renewal, visa, and/or other entrance approval.

Personnel travel administrator 520 may utilize machine learning and/or a large language model to automate the submission of information, filing of documents, processing of fees (e.g., visa fees) and/or completion of administrative requirements for traveling. In doing so, personnel travel administrator 520 may also use artificial intelligence to detect opportunities for selling services, including travel insurance, private services, and/or other related administrative services. For example, personnel travel administrator 520 may utilize dynamic packager 560 (discussed below) to offer personalized discounts. In aspects, personnel travel administrator 520 may collaborate with travel recommendation engine 550, itinerary builder, travel agent 510, etc. to provide intelligent, well-matched recommendations to a user.

Various interfaces of system 500 may utilize dynamic packager 560 to intelligently package products and/or services at a discount. Generally, supplier policies can bar vendors from selling individual products at a discount. Therefore, it is crucial to understand these complex policies in order to prevent supplier discrepancies. Dynamic packager 560 may utilize artificial intelligence trained to identify and/or predict discount conditions that satisfy vendor policies. In doing so, dynamic packager 560 may provide packaged bundles or products and/or services together at a discount, while complying with supplier and regulatory requirements, such as specific supplier rules and policies. This provides the benefit of automatically bundling and/or activating discounts based on complex, detailed supplier and regulatory rules and policies.

For example, dynamic package 560 may automate determination of which products to package and discount, when to activate/deactivate discounts, and/or what conditions must be satisfied (e.g., time period, quantity, and/or price). Moreover, the practice of bundling specific products together as a “package” effectively conceals discounts applied to any individual product. In aspects, dynamic packager 560 may allow a user to preselect rules, variables, products, discount ranges, and/or conditions for activating and deactivating said discounts. The rules involved may be as simple or as complex as needed.

Various interfaces of system 500 may utilize visual promoter 530 to promote travel products and/or services, such as recommendations from travel recommendation engine 550. In doing so, visual promoter 530 provides the benefit of visual tools to promote product and/or services, which include the actual user as the main actor. Thus, the user no longer needs to use their imagination to realize the potential benefits of the products and/or services. For example, during the “discovery path” where a user seeks travel ideas, photos and/or videos may be displayed in real-time, which promote products using the user, family, and other companions as the actors.

Visual promoter 530 may utilize artificial intelligence, large language models, and/or machine learning with visual rendering tools to produce promotional photos and videos. In aspects, visual promoter 530 may use deep fake technology to include the user and other individuals (e.g., family members, friends, and/or companions) in a promotional photo or video using base templates. Visual promoter may obtain a user's face from a profile photo and/or video on system 500 (e.g., profile picture uploaded to user profile), system 500, and/or an alternative source such as a social media profile. For example, while speaking with travel agent 510, the chatbot screen may present a video saying, for example, “imagine seeing yourself . . . ” including the user in various activities such as zip lining, skiing, surfing, etc. with picturesque backgrounds of various destinations.

In aspects, system 500 may include a multi-agent architecture, with multiple agents operating in real time to assist with different tasks and/or events, each configured with a distinct functional role and individualized persona. For example, system 500 may include agents such as a family dining agent, a night-out agent, a vacation agent, or a business travel agent, each of which is trained to respond to user inquiries and perform actions relevant to their specialized context. In another example, each interface of system 500, such as travel agent 510, personnel travel administrator 520, visual promoter 530, itinerary builder 540, travel recommendation engine 550, and a dynamic packager 560, may include a personalized agent. In another each agent may be configured to generate a travel recommendation within a distinct category, for example, lodging, transportation, dining, entertainment, and/or activities

In aspects, each agent may include a different persona reflective of the type of interaction it supports. For instance, a family dining agent may adopt a warm, casual tone and present recommendations tailored for group dining with children, whereas a night-out agent may adopt a more enthusiastic, socially oriented persona and recommend trending venues with late-night availability. Each persona may be derived using neural network-based modeling of user tone, context, past selections, and demographic profiles, and/or may dynamically adapt based on the interaction history of a session. For example, each persona may be derived using a context-aware neural network models, such as transformer-based architectures (e.g., BERT, GPT, or T5), which are well-suited for processing user tone, session context, past selections, and demographic profiles. These models are capable of encoding long-range dependencies in user interactions and extracting semantic patterns that inform the construction of dynamic personas.

In aspects, agents may also be layered in a hierarchical or modular fashion such that, for example, a “vacation agent” may delegate subtasks to nested agents such as a “local activities agent,” “accommodation agent,” or “concierge booking agent.” These agents may interact with one another behind the scenes to coordinate responses and bookings in a seamless, unified manner, while still preserving each agent's specialized capabilities. Additionally, in some implementations, users may maintain separate personas (e.g., business vs. leisure) within their profile, allowing the system to select the appropriate agent or agent cluster based on the user's selected context or implicit behavioral cues.

In aspects, each agent may include a custom skin tailored with specific tools, vocabulary, and UI elements, further reinforcing the immersive and personalized experience. These custom skins serve not only as visual themes but also define the agent's functional scope and conversational style. For example, a family dining agent may present a playful, family-friendly interface with larger buttons, illustrated icons, and simplified language to facilitate use by all age groups, while a corporate travel agent may use a more streamlined interface with formal language, rapid-booking shortcuts, calendar synchronization tools, and expense categorization features (e.g., customizing a vocabulary, a layout, and/or interface tools). The vocabulary used by each agent may be contextually adapted to the use case (e.g., a nightlife agent may include colloquial or trend-based expressions and familiarity with local event slang, whereas a health and wellness agent may use more formal and supportive phrasing, drawing on health-conscious terminology). The user interface elements of each skin may also include context-aware prompts, predictive suggestions, and agent-specific filters, dynamically generated based on the user's profile and real-time intent. In some implementations, the system may allow a user to toggle or preview different agent skins, or the skin may automatically adjust based on usage history, detected tone, or session type, providing a visually and linguistically cohesive experience aligned with the user's goals.

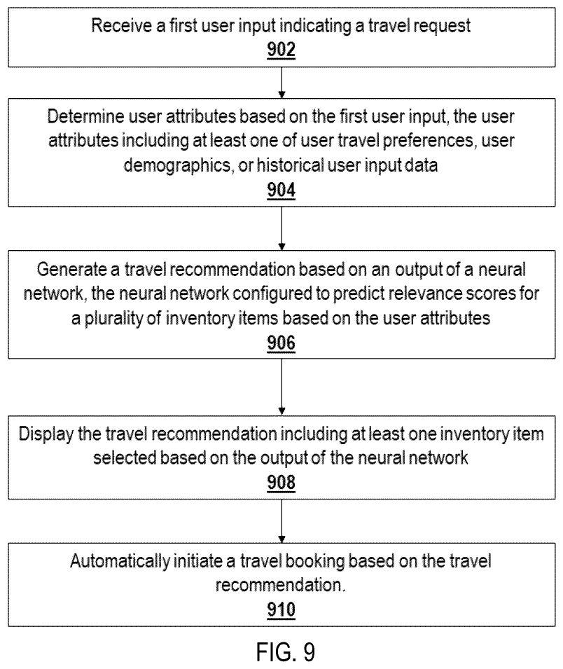

FIG. 9 shows a method 900 for an exemplary use of the system 500. Although the steps of method 900 of FIG. 9 are shown in a particular order, the steps need not all be performed in the specified order, and certain steps can be performed in another order. For example, FIG. 9 will be described below, with a server (e.g., controller 200 of FIG. 2) performing the operations. In various aspects, the method 900 of FIG. 9 may be performed all or in part by controller 200 of FIG. 1. In other aspects, the method 900 of FIG. 9 may be performed all or in part by another device, for example, a mobile device and/or a client computer system. These and other variations are contemplated to be within the scope of the present disclosure.

Initially, at step 902, the controller 200 causes system 500 to receive a first user input indicating a travel request. In aspects, a user may directly inquire with the system 500, for example, stating “I want to go to Florida on XX date.” In aspects, the system 500 may generate a travel questionnaire, which contains structured questions used by system 500 to gather user data and preferences related to travel products and/or services. The travel questionnaire may include multiple-choice, yes/no, Likert scale (e.g., rating from 1 to 5), open-ended, and/or ranking questions. For example, the travel questionnaire may initially generate a splash screen with the phrase “Where would you like to go?” Based on the user's response, the controller 200 may cause system 500 to generate a logical bundle of sections and/or categories designed to obtain and/or process the user's destination preferences, accommodation preferences, activity preferences, and travel logistics. The questionnaire may collaborate with various interfaces of system 500, such as travel agent 510, to gather the required information. For example, a secondary dialogue box may pop up on a chatbot of travel agent 510 stating, for example, “Let's get some info about you first.” The travel questionnaire may utilize statistical analysis techniques to derive insights and inform decision-making in generating the travel questionnaire. For example, the travel questionnaire may analyze the information to identify patterns, trends, and/or preferences among respondents, which dynamically adjust and/or create additional prompts on the travel questionnaire.

Travel agent 510 may gather user preferences, including travel destination(s), timeframe, duration, and/or budget. A user may be presented with the option to type free text and/or select from pre-displayed options. For example, a user may select a travel preference, or travel agent 510 may display a suggested destination that is currently popular, such as St. Thomas. If a user enters a preferences, e.g., that they prefer to travel to the Caribbean during the winter, a secondary prompt may display further data to be collected from the user. For example, the prompt may include selection of particular months, days and weeks for selection, specific locations within a country, preferred airlines, etc. This secondary prompt may include interactive components within a graphical user interface (GUI), such as dynamic calendar, world map, radio buttons, and/or sliding scales, which provide the benefit of an informative visually pleasing experience with ease of data entry. The user may then be able to select finer details, such as preferred hotel locations, temperature, flight duration, etc. For example, the user may state that they only want to stay in a particular level of suite within a certain hotel chain on the island, and/or only fly within business class on a pre-selected airline.

Next, travel agent 510 may prompt user to enter demographics, including age, location, interests, etc. For example, travel agent 510 may ask user to select a particular age range bracket, which bring the user to a second screen requesting further data such as gender and location. Such data may be useful for providing recommendations, which are popular among individuals within a similar demographic. In addition, a user may be requested to submit personal information for documentation purposes, including legal name, address, phone number, and/or billing information.

Next, at step 904, the controller 200 causes system 500 to determine user attributes based on the first user input, such as user travel preferences, demographics, and/or historical input data. In doing so, system 500 may generate a user profile based on the information collected in the travel questionnaire. The user profile and/or interface may be automatically generated based on the user's selections. In aspects, the user profile may be generated using artificial intelligence trained to analyze the user information from the travel questionnaire to understand user preferences, behaviors, and/or characteristics. The artificial intelligence may gather additional user information to improve future analysis, including browsing behavior, past travel history, social media activity, reviews, and/or further preferences indicated through interactions with system 500 and/or other platforms. For example, the artificial intelligence may track user behavior on the system 500, including pages visited, time spent on each page, clicks, searches, and/or interactions with various elements thereof. This behavioral data can be used to infer users' interests, preferred destinations, preferred travel dates, and other relevant factors. For example, system 500 may utilize the artificial intelligence to fill in gaps within the questionnaire, such as missing preferences on flight times, airlines, hotels, etc. based on selections by individuals within a similar demographic. Such information may be displayed differently from user entered information, e.g., in a grey box with a prompt saying “Did you forget something? Here's what we think you meant to put.”

The user profile may be editable and/or customizable by a user. For example, in a first tab, a user may be able to edit their personal data such as legal name, address, phone number, and/or billing information. In another example, in a second tab, the user may be able to edit a variety of travel preferences including locations, dates, times, etc. In addition, the user may be able to enter historical travel information such as prior destinations, including likes and dislikes. In aspects, artificial intelligence may be employed to dynamically adjust the content and/or layout of the profile and/or various interfaces within system 500 based on the user's preferences. For example, the artificial intelligence can customize homepage displays, search results, recommendations, and/or promotional offers by collaborating with various interfaces such as travel recommendation engine 550 to match the user's interests and preferences.

In aspects, the user may be able to select a profile image. Travel agent 510 may request the user to upload a photo and/or video containing an image of the user. For example, the user may upload a front-facing image of their face on a blank background, similar to a passport photo. Alternatively, travel agent may utilize a system camera on the user's device to take photographs, moving images, and/or videos, which may include different angles and/or directions of the face. These photographs and/or videos may be used by visual promoter 530 at a later stage to generate promotional photos and videos including the user. In aspects, travel agent 510 may prompt a user to upload or create a digital avatar, which may be used in addition to and/or in place of a user photo for privacy purposes.

In aspects, system 500 may utilize artificial intelligence such as computer vision and/or machine learning techniques to extract information from the photographs and/or videos. For example, artificial intelligence algorithms may be utilized to estimate the age and/or gender of the user by analyzing facial features and other visual cues. In another example, artificial intelligence algorithms may analyze facial expressions to infer emotions, and/or perform biometric analysis (e.g., facial symmetry, eye movements) may correlate with specific personality traits, such as mood or temperament. For instance, a smiling expression might suggest a more extroverted or positive personality. Thus, the system 500 may be more likely to match recommendations for the user based on similar personality types. In still another example, the artificial intelligence algorithms may analyze the context surrounding the photo or video, such as the environment, activities, and social interactions depicted, AI may infer certain preferences or personality traits. For example, the background of an uploaded photo may contain a beach and volleyball court, suggesting activities that may be recommended to the user.

Next, at step 906, the controller 200 causes system 500 to generate a travel recommendation(s) based on the user information gathered in steps 902-904. The recommendations may be generated using recommendation systems, such as travel recommendation engine 550, which may employ artificial intelligence and/or machine learning (ML) to generate a vector based on the inventory items (hotel, flight, etc.) and the user's attributes (e.g., user behavior, preferences, and/or similarities to other users). For example, a recommendation(s) may be based on an output of a neural network configured to predict relevance scores for inventory items based on the user attributes.

The user's information may be preprocessed to clean, normalize, and transform it into a format suitable for analysis, then the relevant features may be extracted and given weighted values. The preprocessed information may be used to pre-train an artificial intelligence algorithm, such as a neural network or a group of neural networks. The inventory items and/or features can be represented as a vector, which is multiplied by a weighting factor (e.g., using an attribute to determine relevance). A sun of weighted factors may determine a relevance score.

In aspects, time-related features such as preferred travel seasons, vacation durations, and booking patterns can be included and/or factored in. In aspects, destination information, including attributes such as location, climate, attractions, and amenities, can be embedded into a vector(s), which is multiplied by a weighting factor, facilitating comparison and recommendation tasks. The feature vectors may then be used to calculate similarity scores between users and destinations. In aspects, user's preferences, travel history, demographics, and/or other relevant information can be represented as a vector(s).

Based on the calculated scores and user-specific features, recommendation algorithms may rank destinations and/or travel packages to generate a personalized list of recommendations that match the user's preferences and characteristics. For example, system 500 may generate a list of top-N recommendations ranked according to their predicted relevance or likelihood of user interest (e.g., top destinations, top travel dates, top airlines, and/or top hotels).

Next, at step 908, the controller 200 causes system 500 to display the travel recommendation including at least one inventory item. Generally, the list of recommendations may be displayed within various interfaces of system 500. For example, itinerary builder 540 may include a promotional image, which may be generic or personalized to the user with the assistance of visual promoter 530. To do so, deep learning models (e.g., deep fake technology), such as generative adversarial networks (GANs) or autoencoders, are trained using the collected images to generate realistic images and/or videos of the user's face. The deep learning models learn to map the features of the consumer's face onto the promotional content by integrated the synthesized images and/or videos into designated areas of the content. Integration of the user may involve aligning facial features, adjusting lighting and perspective, and/or blending the user's face with the surrounding environment. The promotional content may be further personalized to include elements tailored to the user's preferences, demographics, and/or past interactions, such as for example incorporating the user's name, interests, and/or purchase history into the script or visuals. Such targeted advertising uses technology that complies with applicable laws and regulations, including data privacy and advertising standards.

In addition and/or alternatively, an interface such as itinerary builder 540 may display a landscape view of a vacation destination along with details of the recommendation below (interface 600 of FIG. 6). In aspects, an interactive module may be included on an interface, such as itinerary builder 540 and/or travel agent 510, which initiates generation of new recommendations (e.g., a button “Let's go!”). In another example, travel agent 510 may generate and present recommendations directly within a chatbot screen, which may display text and/or audiovisual output stating “based on your responses, we recommend traveling to . . . ” with details of a proposed trip.

In aspects, the system 500 may receive and/or dynamically process a response from the user. As the user interacts with the recommendations, their feedback and interactions are incorporated back into the system 500 in a feedback loop (e.g., via a chat session database), which continuously refines the feature vectors and improves the accuracy and relevance of future recommendations. For example, the user interacts with travel agent 510 to modify the recommendation and/or restart the process. During this feedback loop, the feature vectors may be refined and/or the accuracy and relevance of future recommendations may be improved. For example, the user can prompt travel agent 510 regarding further inquiries to make an informed decision. This provides the benefit over the current technology by providing a fully interactive, informative booking experience, which includes both speech recognition and vocal tone matching, which current technology is unable to provide.

For example, the user can say “What would change if we moved our flight departure to Monday?” or “Why did you recommend hotel X instead of hotel Y?” In response, travel agent 510 may provide a detailed explanation, which is based on artificial intelligence trained on a variety of travel sites, reviews, recommendations, demographic data specific to the user, etc. In doing so, travel agent 510 may utilize automatic speech recognition (ASR), natural language processing (NLP) and/or tone matching to intelligently revise a tone and pattern of based on the user's responses, which may dynamically match speech patterns and/or a persona of the user. For example, to ASR may extract speech signals into a sequence of feature vectors using techniques such as Mel Frequency Cepstral Coefficients (MFCCs) or spectrograms. Once transcribed, NLP techniques may analyze the text using tasks such as tokenization, part-of-speech (POS) tagging, named entity recognition (NER), sentiment analysis, and/or intent recognition. Then, to revise the tone, system 500 may determine a vector based on the user's speech pattern, which is multiplied by a weighting factor to cause a shift in tone that best matches the user's speech pattern. It will be understood that various alternative techniques are contemplated and within the scope of this disclosure.

Next, at step 910, the controller 200 causes system 500 to automatically initiate a travel booking. The final trip plan may be displayed on a secondary screen of travel agent 510 with a full list of providers, services, pricing, and a potential itinerary. Travel agent 510 may present the user with the option to select add-ons now (e.g., for a bundle deal) or later. In aspects, booking may be completed automatically by travel agent 510 and/or itinerary builder.

For example, travel agent 510 may communicate with a third party to automatically book a flight at the best deal based on artificial intelligence. To book the flight, travel agent 510 may employ artificial intelligence to formulate search query for available flights that meet the user's criteria, while considering factors such as availability, price, duration, airline preferences, and layover times. This query may involve accessing airline databases, global distribution systems (GDS), or third-party travel APIs to retrieve relevant flight information. The system 500 may facilitate the payment process, allowing the user to securely enter their payment details and complete the booking transaction, which can involve integrating with payment gateways or third-party payment processors to handle payment authorization and processing. After the booking is successfully completed, travel agent 510 generates a booking confirmation and issues an electronic ticket to the user. For example, the user may receive confirmation of their flight, hotel, and/or car reservation via email, short message service (SMS) message, push notification, phone call, and/or notification within an interface of system 500. Travel agent 510 may provide post-booking assistance to the user, including itinerary management, flight status updates, check-in reminders, and/or assistance with any changes or cancellations to the booking.

In another example, travel agent 510 may communicate with a restaurant to automatically make a reservation based on the user's stated preferences and information. To do so, travel agent 510 may extract key information such as reservation date, time, and preferences from the user's responses and formulate a query to search for available restaurant reservations, which may involve accessing restaurant reservation databases, booking platforms, and/or third-party APIs to retrieve relevant information. Travel agent 510 may search for and/or contact available restaurants that meet the user's criteria, considering factors such as availability, cuisine, location, ratings, and price range. Travel agent 510 may automatically contact the restaurant to make the reservation (e.g., phone, SMS, e-mail, and/or chatbot). While conversing with the restaurant, travel agent 510 may utilize the artificial intelligence and/or machine learning techniques described above to perform speech recognition and vocal tone matching to match a speech pattern and/or tone of the user or restaurant employee. Thus, the restaurant can directly interact with travel agent 510 to determine the optimal reservation location, seating and/or time while seemingly communicating with a human. In aspects, a live transcript of the conversation may be transmitted to the user in a real-time or historical format as a reference document. In aspects, the reservation may be automatically added to a calendar or scheduling application of a user device (e.g., mobile device calendar app). Once the reservation is successfully confirmed, travel agent 510 provides a booking confirmation to the user. Travel agent 510 may provide post-booking assistance, including reminders about the reservation, directions to the restaurant, and/or assistance with any changes or cancellations to the reservation.

In aspects, the system 500 may also generate a travel itinerary. For example, itinerary builder 540 may produce a detailed description containing travel, activities, and additional information organized by date and/or departure/arrival (interface 700 of FIG. 7). Itinerary builder 540 may incorporate interactive maps to visualize the locations of various attractions, accommodations, and activities, helping users understand the geographical layout of their itinerary. Further, itinerary builder 540 may real-time updates and notifications regarding changes to travel plans, such as flight delays, cancellations, or itinerary adjustments, ensuring users stay informed throughout their trip. In aspects, itinerary builder 540 may offer collaboration features that allow users to share their itineraries with travel companions, friends, or family members, facilitating coordination and communication during the trip planning process. Itinerary builder 540 may also offer offline access to users, allowing them to access their travel plans and information even without an internet connection, useful for when they are traveling to remote or unfamiliar destinations.

In aspects, add-ons may be displayed for products and/or services such as rentals (e.g., vehicles, equipment, etc.), hotels, activities, and/or reservations. The add-ons may be provided directly through system 500 or via a third-party provider. Once complete, the user can select to book the entire trip or individual aspects (e.g., flight, hotel, and/or add-ons alone). Itinerary builder 540 may be integrated with various booking platforms and/or travel providers to allow users to streamline booking of such add-ons. In doing so, users may be provided with access to feedback and/or reviews from other travelers about various destinations, accommodations, and/or activities, helping them make informed decisions.

In aspects, alerts and/or links to an additional screen may be provided for managing travel-related documentation, such as passport and/or visa information. For example, the user may select a button saying “Documents-Passport Missing!” which will prompt them to upload and/or renew their passport information (interface 700 of FIG. 7). This button and/or other interactive interfaces (e.g., a tertiary screen) may cooperate with personnel travel administrator 520 to assist with and/or expedite administrative tasks, which are required for domestic or international travel (interface 800 of FIG. 8). For example, the personnel travel administrator may streamline the process of applying for entry into/exit from a country, including various visas, thereby ensuring efficiency and compliance with various state policies. The personnel travel administrator may also automatically monitor and/or dynamically update the status of various documentation such passports to ensure user information is up-to-date in advance of traveling.

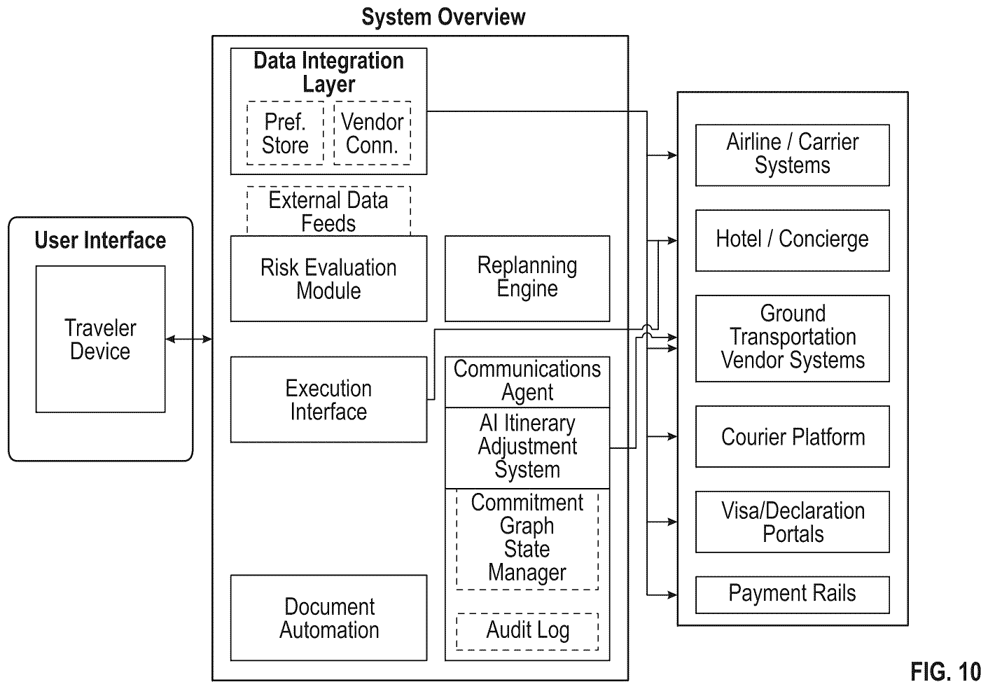

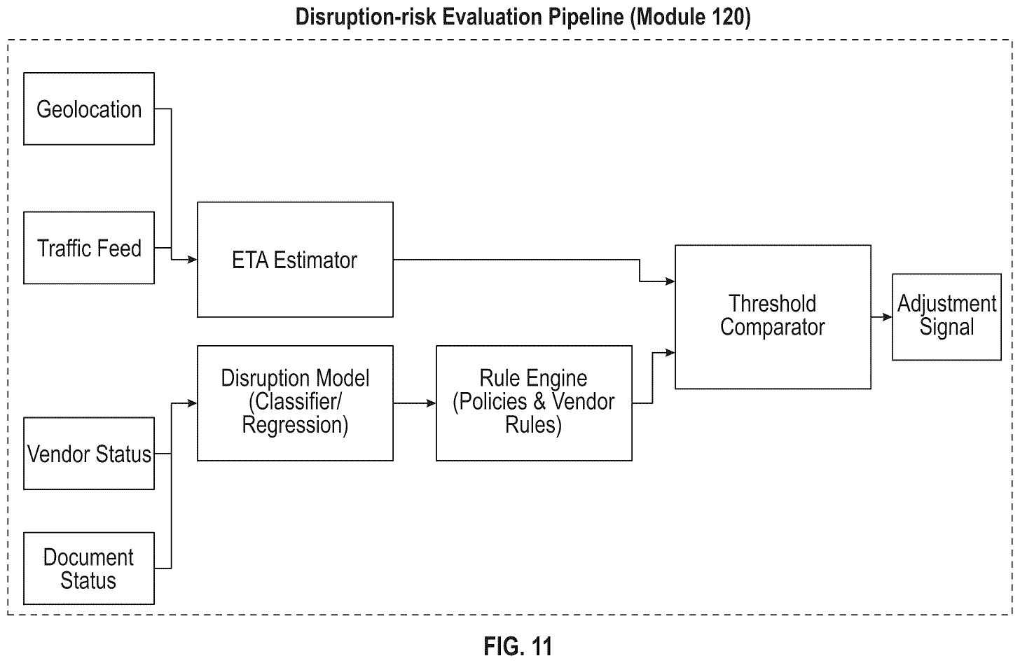

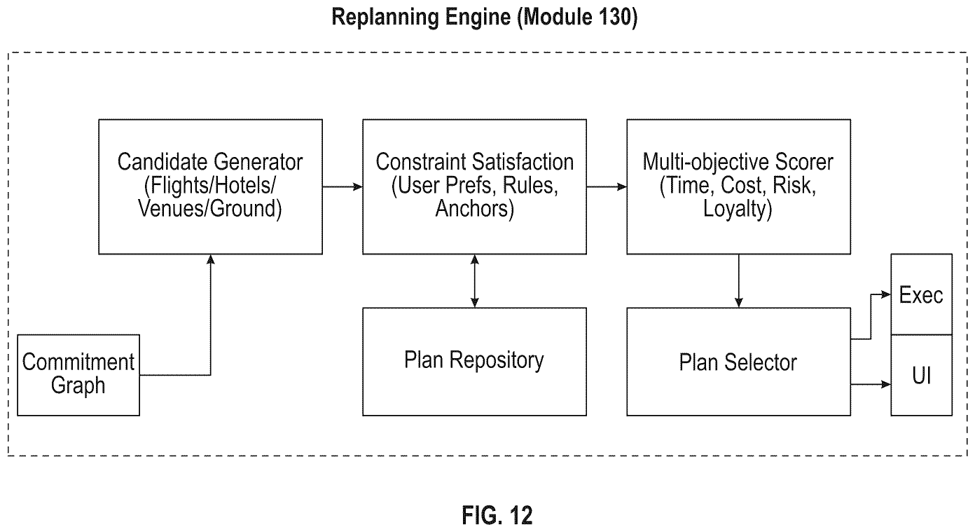

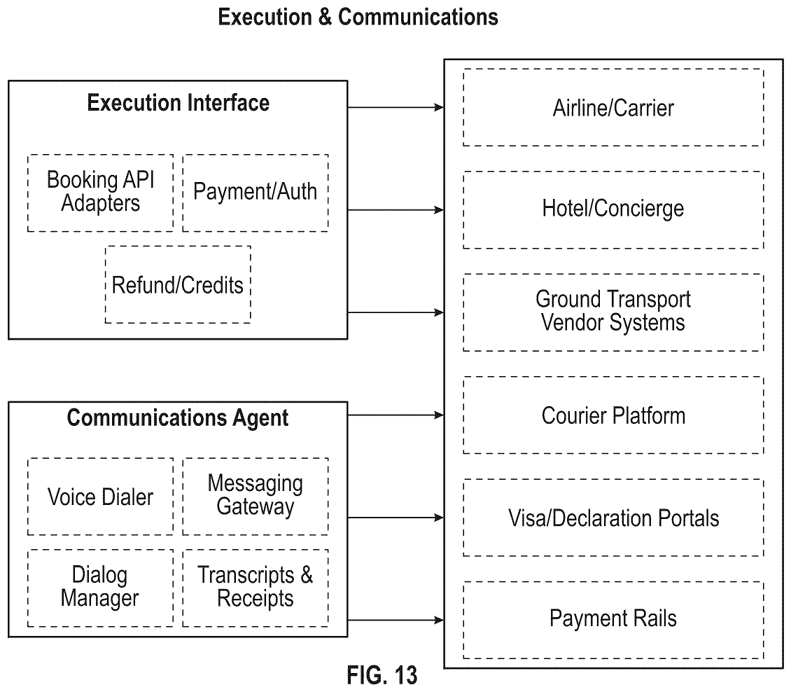

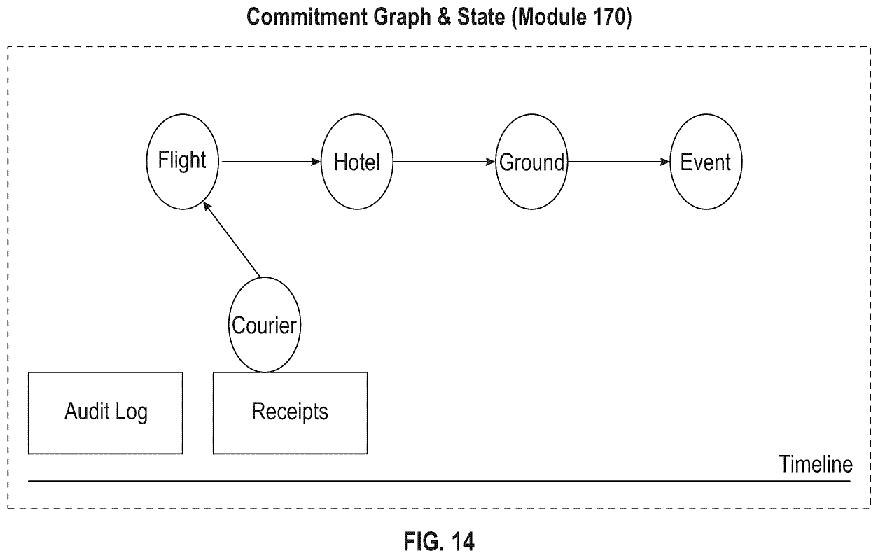

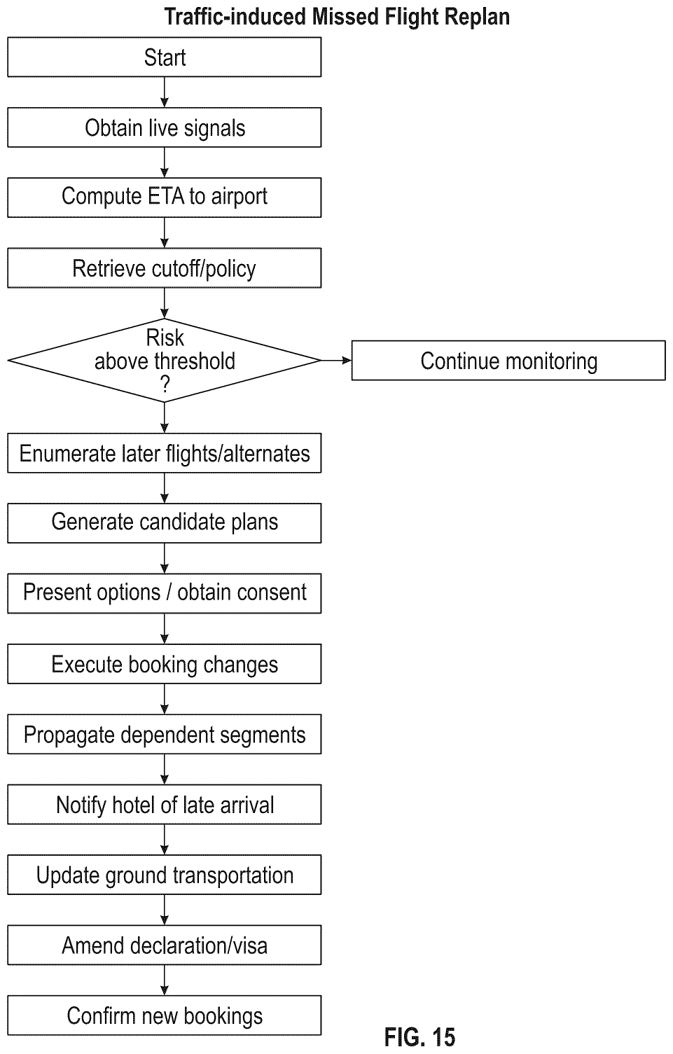

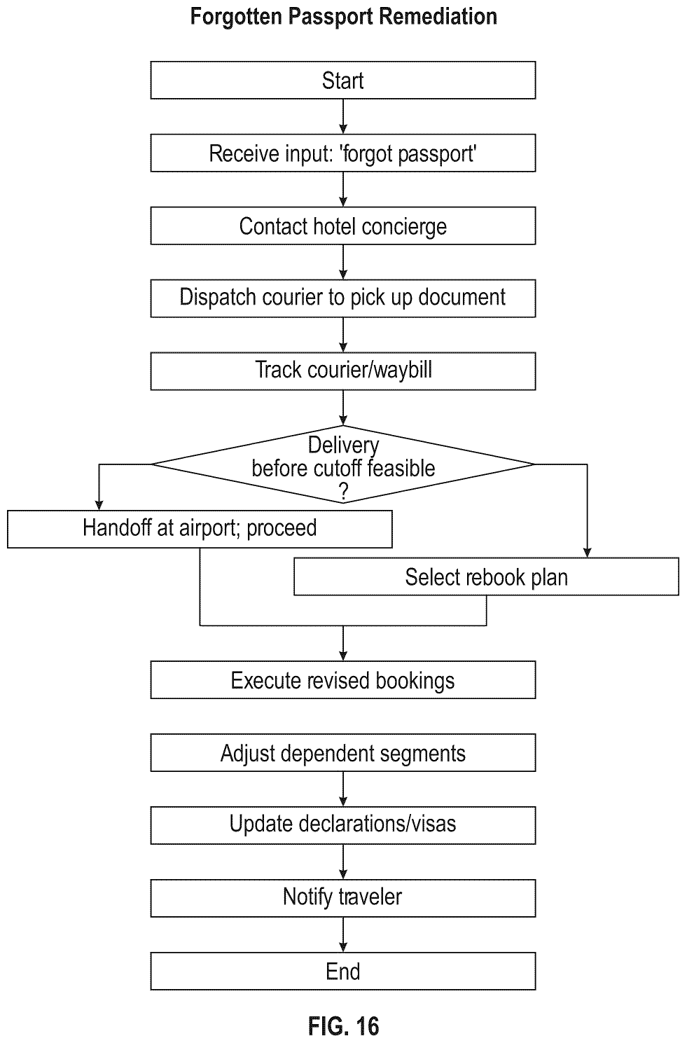

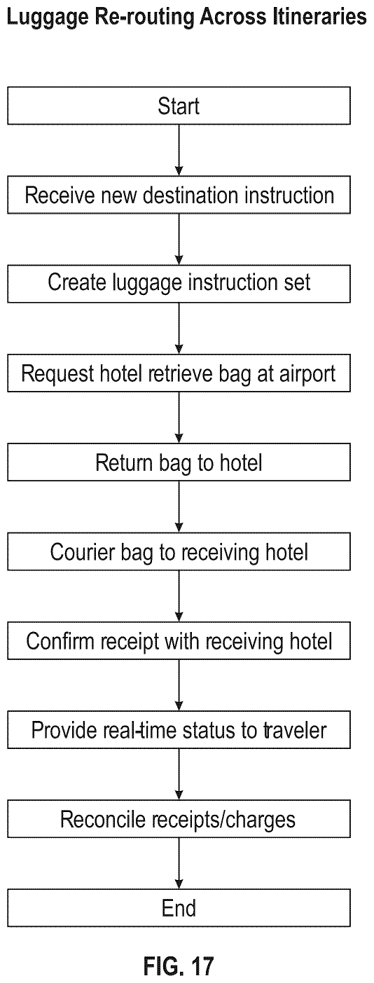

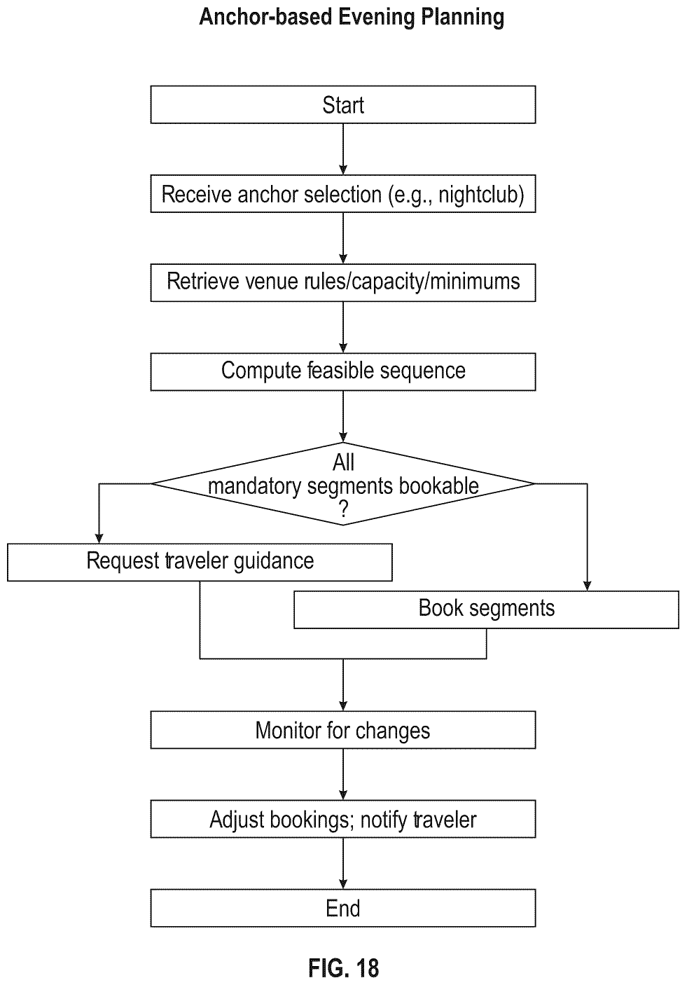

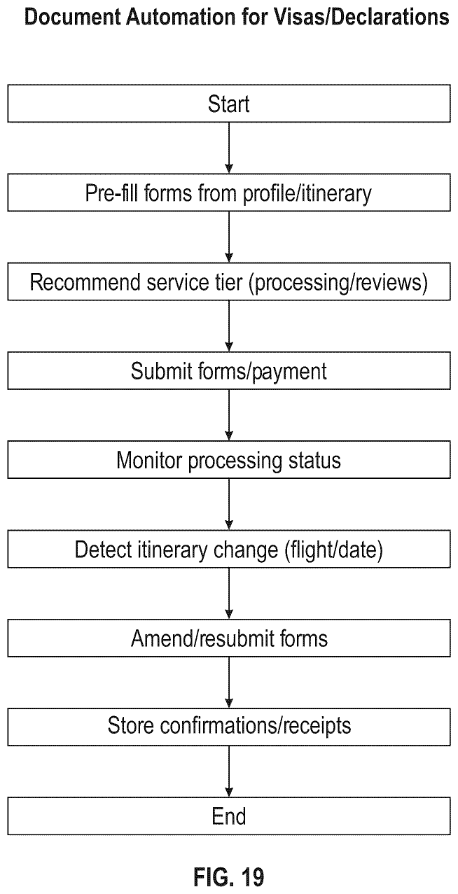

As shown in FIGS. 10-19, in aspects, the system 500 may further include an artificial intelligence adjustment concierge that extends the functionality of itinerary builder 540 to manage dynamic changes in a user's travel itinerary in response to real-world events, triggers, and conditions detected through continuous monitoring of data sources. The artificial intelligence adjustment concierge may operate in conjunction with itinerary builder 540, personnel travel administrator 520, and other subsystems of system 500 to provide a seamless, adaptive travel experience. The artificial intelligence adjustment concierge may utilize geolocation, navigation, mapping, traffic, flight status, hotel reservation systems, venue reservation systems, concierge communication interfaces, and other external or internal data sources to predict and detect disruptions before they occur. The artificial intelligence adjustment concierge may determine, based on the correlation of such data, whether a current itinerary segment can still be completed as planned, and may automatically begin evaluating alternative options when a deviation threshold is met. Upon identifying a potential disruption, the artificial intelligence adjustment concierge may initiate an interactive dialogue with the user through a conversational interface, such as travel agent 510, to confirm preferences, tolerances, or priorities for automated decision-making, and may thereafter coordinate appropriate modifications to the user itinerary in real time.

The artificial intelligence adjustment concierge may communicate directly with service providers through application programming interfaces, chat, text, voice call, or email to cancel, modify, or confirm arrangements, thereby replicating the actions of a live human concierge. The artificial intelligence adjustment concierge may also perform multi-segment synchronization, ensuring that any change to one portion of the itinerary automatically propagates through dependent elements such as connecting flights, ground transportation, hotel check-in or checkout times, restaurant or event reservations, and local activity bookings. In aspects, the artificial intelligence adjustment concierge may further monitor dependent or related itinerary data, such as visa or entry requirements, travel declaration forms, or documentation expiration dates, and coordinate completion or revision of such information through personnel travel administrator 520 when changes occur. The artificial intelligence adjustment concierge may continuously update itinerary builder 540 with revised confirmations, vendor communications, and transaction data so that a unified itinerary record is preserved and synchronized across all user devices and connected systems.

In an exemplary embodiment, the artificial intelligence adjustment concierge may determine, based on the user's current location, route information, and real-time traffic data, that the user will not reach an airport on time for a scheduled departure. The artificial intelligence adjustment concierge may continuously compare the estimated arrival time to the airport with one or more threshold times, including boarding cutoff time, check-in closing time, and security clearance time, and upon determining that one or more thresholds are exceeded, may automatically generate an alert within the user interface of itinerary builder 540 or travel agent 510. The artificial intelligence adjustment concierge may notify the user of the detected risk and present suggested options, including identifying later flights, alternative airports, or substitute modes of transportation such as private transfers, rail connections, or rideshare vehicles.

Upon user approval, the artificial intelligence adjustment concierge may execute rebooking procedures by accessing one or more connected booking platforms or reservation systems, cancelling prior reservations, confirming new travel segments, and reconciling associated costs or credits in accordance with carrier or vendor policies. The artificial intelligence adjustment concierge may automatically communicate with relevant providers to confirm updated arrangements, including reissued boarding passes, seating assignments, and baggage transfers. The artificial intelligence adjustment concierge may also adjust subsequent segments of the itinerary affected by the new departure time, including updating airport transfer reservations, notifying connecting carriers, modifying ground transportation at the destination, and adjusting hotel check-in schedules and activity start times.

The artificial intelligence adjustment concierge may further coordinate with a destination hotel or concierge system to notify staff of the updated arrival time, ensure that a guest room remains reserved for late arrival, and confirm revised arrangements for any pre-scheduled services such as dining, spa appointments, or event attendance. The artificial intelligence adjustment concierge may also notify third-party transportation vendors or local service partners of revised pickup times and ensure that replacement drivers or vehicles are dispatched as necessary. Throughout this process, the artificial intelligence adjustment concierge may provide the user with a real-time summary of each completed action, display updated confirmations, and issue push notifications to maintain transparency. Each of these operations may be recorded within itinerary builder 540 so that the user's travel plan remains consistent, accurate, and up to date across all devices and systems connected to system 500.

In another exemplary embodiment, the artificial intelligence adjustment concierge may respond to an unforeseen user situation such as a missing or forgotten travel document. For example, when a user reports, through a voice or text interaction with travel agent 510, that a passport or other identification document was left behind at a hotel, the artificial intelligence adjustment concierge may automatically retrieve relevant information from itinerary builder 540, including the hotel name, room number, and reservation details, and may initiate communication with a concierge service or front desk at the identified property. The artificial intelligence adjustment concierge may provide the necessary details regarding the user's identity, location, and departure schedule, and may request retrieval of the item from the room, safe, or other location where it was last recorded. The artificial intelligence adjustment concierge may then arrange transport of the document by coordinating a courier, hotel staff member, or authorized transport service to deliver the document to the user's current location, such as an airport, train station, or other designated checkpoint.

In embodiments, the artificial intelligence adjustment concierge may communicate with multiple parties during the recovery process, including hotel personnel, courier services, airport personnel, and travel companions, using application programming interfaces, direct messaging, telephone calls, or other communication channels. When interacting by telephone, the artificial intelligence adjustment concierge may conduct natural language conversations, repeat requests as needed, and escalate the matter to a higher authority, such as a hotel manager or supervisor, until confirmation is received that retrieval and transport are underway. During transit, the artificial intelligence adjustment concierge may monitor the courier's progress through integration with a delivery tracking system, geographic information system, or vendor application, and may provide the user with continuous or periodic updates regarding the status of the document retrieval, estimated delivery time, and confirmation of receipt.

If the artificial intelligence adjustment concierge determines, based on real-time tracking and time-to-departure analysis, that the document cannot be delivered to the user before scheduled departure, the artificial intelligence adjustment concierge may automatically initiate a sequence of itinerary adjustments. These adjustments may include rescheduling the user's flight, rebooking connecting segments, revising ground transportation and hotel arrival times, and notifying the destination concierge or other service providers of the revised arrival. The artificial intelligence adjustment concierge may also cancel or modify any dependent event, activity, or reservation impacted by the delay. All communications, confirmations, and document transfer details may be recorded in itinerary builder 540, allowing the user to view a complete transaction history and ensuring that all elements of the revised itinerary remain consistent, accurate, and synchronized across system 500.

In another exemplary embodiment, the artificial intelligence adjustment concierge may manage complex multi-itinerary or multi-destination scenarios. In such cases, a traveler may alter one or more travel segments after departure, such as deciding to change destinations, combine multiple itineraries, or bypass a check-in process for a previously scheduled flight. The artificial intelligence adjustment concierge may automatically assess the operational and logistical impact of such changes and may initiate actions to coordinate the retrieval, redirection, or delivery of luggage and other personal items associated with the traveler. For example, if a traveler departs for a new destination and decides not to board a scheduled flight, the artificial intelligence adjustment concierge may identify that luggage has been checked or transferred to an airport holding area, and may contact the hotel from which the traveler departed or the airline handling service to arrange for retrieval of the luggage.

The artificial intelligence adjustment concierge may then arrange for a courier or hotel staff member to collect the luggage from the airport or other specified location, verify proper chain of custody, and ensure that the luggage is delivered safely to a second hotel or alternate lodging associated with the traveler's revised itinerary. The artificial intelligence adjustment concierge may generate and transmit retrieval and delivery instructions, including identification data, reference numbers, and authorization credentials, to the involved parties. The artificial intelligence adjustment concierge may maintain continuous communication with all participating entities, such as hotel concierge staff, airline baggage handlers, and courier operators, through APIs, phone calls, messages, or secure digital interfaces, to ensure uninterrupted coordination and verification of each stage of the process.

During transit, the artificial intelligence adjustment concierge may monitor the movement of the luggage by integrating with a delivery tracking system or courier telemetry feed, and may provide the user with detailed notifications indicating the current status of the luggage, including pickup confirmation, transit checkpoints, and estimated arrival time at the destination. Upon successful delivery, the artificial intelligence adjustment concierge may confirm receipt with the receiving hotel or lodging provider, record digital proof of delivery, and update the traveler's itinerary to reflect completion of the luggage transfer. The artificial intelligence adjustment concierge may provide the user with receipts, delivery confirmations, and audit records for each completed stage of the operation, which may be viewable through itinerary builder 540.

The artificial intelligence adjustment concierge may also update the overall travel plan stored within itinerary builder 540 to reflect all revised destinations, transportation segments, and lodging details, ensuring consistency across related itineraries. The artificial intelligence adjustment concierge may synchronize these updates with personnel travel administrator 520 so that related documentation, such as hotel invoices, expense records, and travel declarations, are adjusted to match the modified itinerary. Through this functionality, the artificial intelligence adjustment concierge provides a comprehensive and automated system for managing multi-leg travel disruptions, complex luggage logistics, and dynamic reconfiguration of itineraries while maintaining complete transparency and accuracy for the user throughout the process.

In another exemplary embodiment, the artificial intelligence adjustment concierge may assist in managing user-selected evening activities or entertainment sequences, in which multiple options or “anchor” choices define dependent events. The artificial intelligence adjustment concierge may maintain structured activity trees or relational data models that link each event or reservation segment to one or more dependent elements based on time, location, transportation requirements, venue operating hours, and user preferences. For example, when a user constructs an itinerary that includes a cocktail gathering, dinner, a pre-activity event, a nightclub reservation, an after-hours venue, and a return to a hotel, the artificial intelligence adjustment concierge may generate a hierarchical schedule that associates each event with its dependencies and allowable substitutions.

When the user selects a preferred anchor activity, such as a specific restaurant, dinner time, or nightclub venue, the artificial intelligence adjustment concierge may automatically evaluate all preceding and subsequent itinerary components to confirm alignment of timing, travel duration, proximity, and resource availability. The artificial intelligence adjustment concierge may identify conflicts or inefficiencies, such as overlapping time windows, excessive travel distance, or venue access restrictions, and may reconfigure the sequence to ensure feasibility while preserving the user's intended experience. In aspects, the artificial intelligence adjustment concierge may access one or more venue application programming interfaces, online booking systems, or local concierge databases to confirm reservations, table availability, guest limits, and pricing associated with each option.

The artificial intelligence adjustment concierge may dynamically adapt to real-time changes such as party size modifications, table or ticket cancellations, weather interruptions, or venue policy updates. Upon detecting a change, the artificial intelligence adjustment concierge may automatically propose substitute venues or schedule adjustments that maintain the logical structure of the itinerary. For instance, if a nightclub reservation is cancelled, the artificial intelligence adjustment concierge may identify alternative venues of equivalent category and proximity, verify available seating or entry times, and update transportation pickup and return arrangements accordingly. The artificial intelligence adjustment concierge may notify the user of each proposed change, present comparative details, and obtain approval prior to execution when required by user authorization settings.

The artificial intelligence adjustment concierge may also manage variable configurations, such as A, B, and C options preselected by the user for each segment of the evening, allowing quick reconfiguration when a preferred choice becomes unavailable. The artificial intelligence adjustment concierge may track dependencies among these options to ensure that any selection adheres to the timing and sequencing constraints established by the anchor activity. The artificial intelligence adjustment concierge may additionally factor in context-specific rules or limitations, such as venue age restrictions, dress codes, reservation deposit requirements, or group size policies, to prevent invalid combinations and ensure that all reservations remain compliant with local regulations and venue practices.

Throughout this process, the artificial intelligence adjustment concierge may coordinate communications with event hosts, venue management systems, and transportation providers to confirm updated details and ensure continuity of the evening's itinerary. The artificial intelligence adjustment concierge may issue confirmations, reminders, and navigation updates to the user and to participating companions, synchronize all approved modifications with itinerary builder 540, and store complete transactional and communication records within system 500. Through these functions, the artificial intelligence adjustment concierge provides a cohesive and adaptive framework for managing complex social itineraries that evolve in real time while preserving user intent and optimizing convenience.

In embodiments, the artificial intelligence adjustment concierge may interact with personnel travel administrator 520 to automatically complete travel documentation and declarations required by governmental, administrative, or private authorities. For instance, prior to a user flight or border crossing, the artificial intelligence adjustment concierge may determine the applicable visa, entry, health, or customs requirements based on the user nationality, residence, destination, transit points, and itinerary details stored within system 500. The artificial intelligence adjustment concierge may access official government databases, verified travel information sources, or airline and embassy application programming interfaces to retrieve current documentation requirements, submission procedures, and relevant time frames. Upon identifying required documentation, the artificial intelligence adjustment concierge may populate visa, declaration, or registration forms with user data already stored in system 500, including legal name, passport number, contact details, and travel dates, and may generate completed forms for submission or for user review and approval.

In some embodiments, the artificial intelligence adjustment concierge may evaluate documentation submission options and determine an appropriate processing path by analyzing known turnaround times, service reliability metrics, processing trends, and the user departure schedule. The artificial intelligence adjustment concierge may recommend expedited or standard processing routes, courier delivery services, or electronic submission options, and may provide a comparative display of service providers with associated fees, ratings, and verified feedback. Upon user selection or authorization, the artificial intelligence adjustment concierge may transmit completed forms electronically through an official governmental portal or submit the documents through an approved third-party service provider.

The artificial intelligence adjustment concierge may cooperate with personnel travel administrator 520 to verify that all documentation requirements are satisfied and that travel documents such as passports and visas remain valid for the entire duration of travel. In the event of an approaching expiration or incomplete documentation, the artificial intelligence adjustment concierge may generate proactive alerts, present renewal options, and, where permitted, initiate renewal or replacement procedures on behalf of the user. The artificial intelligence adjustment concierge may also ensure that modifications to itinerary builder 540, such as flight rescheduling or revised arrival and departure times, are reflected in all associated travel documents and declarations, maintaining consistency between travel schedules and administrative filings.

Throughout this process, the artificial intelligence adjustment concierge may store a comprehensive record of all completed documentation, submission confirmations, and related correspondence within system 500. Such records may be accessible to the user and authorized service personnel for verification and auditing. Through this coordinated operation with personnel travel administrator 520, the artificial intelligence adjustment concierge maintains accurate and current compliance with travel regulations, reduces administrative burden on the user, and ensures that all documentation required for travel is prepared, validated, and filed in advance of departure.

In yet another exemplary embodiment, the artificial intelligence adjustment concierge may operate as a multi-agent system that learns from historical user behavior, preferences, contextual conditions, and prior itinerary outcomes in order to improve predictive accuracy and response efficiency. The artificial intelligence adjustment concierge may maintain a continuously updated model of user intent, prioritization of itinerary segments, and tolerance thresholds for delay, substitution, or change. The artificial intelligence adjustment concierge may apply statistical or machine learning techniques to refine predictive models through iterative analysis of user interactions, service provider performance data, and environmental factors such as seasonal travel variations or regional reliability patterns.

The artificial intelligence adjustment concierge may support varying levels of automation under user-defined control parameters. A user may authorize the artificial intelligence adjustment concierge to perform certain categories of actions automatically, such as rescheduling ground transportation, updating restaurant reservations, or securing replacement event tickets, while requiring explicit user approval for higher-cost or high-impact changes, such as international flight modifications or non-refundable bookings. These authorization rules may be stored within the user profile and referenced dynamically by the artificial intelligence adjustment concierge prior to executing any automated action. In aspects, the artificial intelligence adjustment concierge may also employ confidence scoring and decision thresholds to determine when predictive actions are appropriate without user confirmation, thereby maintaining efficiency while preserving accountability and user oversight.

The artificial intelligence adjustment concierge may operate in coordination with other functional agents within system 500, including travel agent 510, itinerary builder 540, and personnel travel administrator 520, in order to share data, delegate subtasks, and synchronize actions across multiple domains. Each agent may possess specialized functions that address specific categories of travel planning, logistics, or administrative compliance. The artificial intelligence adjustment concierge may serve as a supervisory entity that harmonizes the activity of these agents, resolves conflicts among proposed actions, and prioritizes execution according to user-defined preferences, urgency, or operational constraints.

In embodiments, the artificial intelligence adjustment concierge may also synchronize updates with connected travel companions, group accounts, or shared itineraries. When one user within a group modifies a reservation or activity, the artificial intelligence adjustment concierge may automatically propagate the change to all affected participants, verify availability for each linked account, and reconcile any resulting inconsistencies. This group synchronization process ensures that all participants maintain an aligned version of the itinerary, reducing confusion and communication delays among travelers. The artificial intelligence adjustment concierge may record each modification and corresponding approval record within system 500, maintaining an auditable history of all automated and user-directed adjustments for transparency and reference.

In all embodiments, the artificial intelligence adjustment concierge operates as an intelligent orchestration layer that integrates itinerary builder 540, personnel travel administrator 520, and various third-party booking, communication, payment, and documentation systems. Through continuous monitoring, predictive analysis, and coordinated action, the artificial intelligence adjustment concierge provides proactive itinerary adjustment, operational resilience, and personalized service consistency throughout all stages of travel. By combining autonomous event management with transparent user authorization and adaptive learning, the artificial intelligence adjustment concierge ensures reliable, efficient, and context-aware orchestration of travel experiences across the full ecosystem of connected services within system 500.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms, or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages that are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above are also intended to be within the scope of the disclosure.

What is claimed is:

1. A system for automated adjustment of a travel itinerary, comprising:
a processor; and
a memory coupled to the processor, the memory having instructions stored thereon that, when executed by the processor, cause the system to:
receive itinerary data including at least one travel segment selected from a flight, lodging, transportation service, event, or activity;
monitor a plurality of data sources including at least one of geolocation data, traffic data, flight data, hotel reservation data, or external event data to detect a potential disruption to the travel itinerary;
determine, based on the detected potential disruption, one or more adjustment options for the travel itinerary;
initiate communication with a user to confirm a selected adjustment option;
execute the selected adjustment option by performing at least one of modifying, cancelling, or rebooking a travel segment; and
update the travel itinerary in real time within an itinerary builder interface.

2. The system of claim 1, wherein detecting the potential disruption comprises comparing a user current location derived from a navigation service to a scheduled departure location and determining that the user will not reach the scheduled departure location within a required time.

3. The system of claim 1, wherein the instructions, when executed by the processor, further cause the system to:
receive a user authorization defining categories of automated actions; and
automatically perform an authorized category of itinerary adjustment without further user input.

4. The system of claim 1, wherein the adjustment options include identifying an alternative flight, rebooking ground transportation, updating hotel check-in times, or rescheduling a travel activity.

5. The system of claim 1, wherein executing the selected adjustment option comprises accessing one or more third-party booking platforms, cancelling a prior reservation, confirming a new reservation, and synchronizing updated information with a hotel concierge system.

6. The system of claim 1, wherein the instructions, when executed by the processor, further cause the system to:
initiate communication with a concierge service at a lodging location;
transmit a message requesting assistance with retrieval or delivery of an item; and
monitor progress of the retrieval or delivery through integration with a courier tracking system.

7. The system of claim 6, wherein the instructions, when executed by the processor, further cause the system to automatically reschedule at least one travel segment in response to determining that the item will not arrive before a scheduled departure.

8. The system of claim 1, wherein the instructions, when executed by the processor, further cause the system to:
coordinate a multi-destination itinerary including at least two travel legs;
communicate with a lodging provider associated with a first destination to arrange retrieval of luggage; and
instruct a courier to deliver the luggage to a second lodging provider corresponding to a modified destination.

9. The system of claim 8, wherein the instructions, when executed by the processor, further cause the system to provide the user with real-time notifications identifying a current location of the luggage, an expected delivery time, and confirmation of receipt at a final destination.

10. The system of claim 1, wherein the instructions, when executed by the processor, further cause the system to:
store a plurality of entertainment or activity options for a given time period;
receive a user selection of an anchor activity;
automatically adjust one or more dependent activities preceding or following the anchor activity based on timing, proximity, or availability; and
coordinate with event hosts, venue systems, or transportation services to confirm all updated reservations.

11. The system of claim 1, wherein the instructions, when executed by the processor, further cause the system, through an artificial intelligence adjustment concierge, to:
determine visa or entry requirements for a destination based on user nationality and itinerary details;
populate visa or declaration forms using user data stored in the system;
analyze processing times and reliability metrics of available service providers; and
submit or prepare the visa or declaration forms for user review and approval.

12. The system of claim 11, wherein the artificial intelligence adjustment concierge and a personnel travel administrator cooperate to verify validity of travel documents, generate alerts for impending expirations, and initiate renewal or replacement procedures as needed.

13. The system of claim 11, wherein the artificial intelligence adjustment concierge comprises a multi-agent architecture configured to learn from historical user behavior, prior itinerary adjustments, and contextual conditions to refine predictive accuracy and decision efficiency.

14. The system of claim 13, wherein the artificial intelligence adjustment concierge maintains a user model including intent data, event prioritization, and tolerance thresholds for delay or modification, and dynamically adjusts decision policies based on the user model.

15. The system of claim 13, wherein the artificial intelligence adjustment concierge synchronizes itinerary updates with connected travel companions to maintain consistency across group travel plans.

16. The system of claim 13, wherein the artificial intelligence adjustment concierge operates as an orchestration layer that coordinates data exchange among an itinerary builder, a personnel travel administrator, and external booking, communication, and documentation systems.

17. A method for automated adjustment of a travel itinerary, comprising:
receiving itinerary data including at least one travel segment selected from a flight, lodging, transportation service, event, or activity;
monitoring a plurality of data sources to detect a potential disruption to the travel itinerary;
determining, based on the detected potential disruption, one or more adjustment options for the travel itinerary;
initiating communication with a user to confirm a selected adjustment option;
executing the selected adjustment option by performing at least one of modifying, cancelling, or rebooking a travel segment; and
updating the travel itinerary in real time within an itinerary builder interface.

18. The method of claim 17, further comprising automatically submitting travel documentation based on a determined visa or entry requirement, the travel documentation populated with user data stored in a user profile.

19. The method of claim 17, further comprising retrieving a user authorization that defines categories of automated itinerary changes and automatically executing an itinerary change within an authorized category without requiring additional confirmation.

20. A non-transitory computer-readable storage medium having instructions stored thereon that, when executed by a processor, cause a system to perform the method of claim 17.
